(19) United States
(12) Patent Application Publication
(10) Pub. No.: US 2026/0073470 A1
(43) Pub. Date: Mar. 12, 2026

(54) SYSTEM AND METHOD FOR MODIFYING A USER POSE IN AN INPUT IMAGE

(71) Applicant: SAMSUNG ELECTRONICS CO., LTD., Suwon-si (KR)

(72) Inventors: Natasha Meena, Noida (IN); Yamani Bharathkumar, Noida (IN)

(73) Assignee: SAMSUNG ELECTRONICS CO., LTD., Suwon-si (KR)

(21) Appl. No.: 19/395,432

(22) Filed: Nov. 20, 2025

Related U.S. Application Data
(63) Continuation of application No. PCT/KR2024/010304, filed on Jul. 17, 2024.

(30) Foreign Application Priority Data
Aug. 21, 2023 (IN) 202311056003

(51) Int. Cl. G06T 3/00; G06T 5/77; G06T 7/246; G06T 7/73; G06T 17/00; G06V 10/25; G06V 10/26; G06V 10/40; G06V 10/70; G06V 10/82; G06V 40/10

(52) U.S. Cl. CPC G06T 3/00; G06T 5/77; G06T 7/246; G06T 7/75; G06T 17/00; G06V 10/25; G06V 10/26; G06V 10/40; G06V 10/768; G06V 40/103; G06T 2207/20081; G06T 2207/20084; G06T 2207/30196; G06V 10/82

(57) ABSTRACT

A method for modifying a user pose in an input image is provided. The method includes extracting, from the input image, a plurality of features associated with at least one user and at least one object and determining one or more possible user interactions with the at least one object. Furthermore, the method includes determining a joint-object score and generating a set of user poses corresponding to the at least one object. Further, the method includes determining a containment score and determining an optimal user pose amongst the generated set of user poses. Furthermore, the method includes modifying the user pose associated with the at least one user and an object orientation associated with the at least one object in the input image.

### CROSS-REFERENCE TO RELATED APPLICATIONS

This application is a continuation of International Application No. PCT/KR2024/010304, filed on Jul. 17, 2024, which is based on and claims priority to Indian Patent Application No. 202311056003, filed on Aug. 21, 2023, in the Indian Intellectual Property Office, the disclosures of which are incorporated by reference herein in their entireties.

### BACKGROUND

### 1. Field

The present disclosure generally relates to the field of image processing, and more particularly relates to a system and a method modifying a user pose in an input image.

### 2. Description of Related Art

With the recent advancements in Artificial Intelligence (AI), there has been an increased focus on development of Human-Object Interaction (HOI) systems. These systems aim to enable humans to interact with objects in their environment using natural language commands. In particular, the HOI refers to the field of study and development that focuses on enabling AI systems to recognize objects and humans, understand properties of objects, and detect visual relations between humans and objects in captured images. This capability of the HOI is crucial for various applications, including robotics, computer vision, augmented reality, pose modification, virtual reality, and the like.

Further, there is a limited scope of the pose modification of a user or an object by using conventional pose modification techniques. In general, availability of a reference pose is required for pose recommendation/transfer methods. The conventional pose modification techniques obtain reference pose data from a skilled model or from social media platforms. However, such reference pose data may not be suitable for all use case scenarios. Therefore, there is a need for automatic reference pose generation. Further, in conventional pose modification techniques, image editing options or video editing options are limited in terms of pose modification. Also, the conventional pose modification techniques are not smart enough to automatically modify or generate the pose of the user and the object in an image frame or a video frame.

Furthermore, the conventional pose modification techniques are used in multiple use-case scenarios, such as health sector, robotics sector, education sector, and entertainment sector. For example, the conventional pose modification techniques may detect yoga/exercise poses and suggest a correction in the detected yoga/exercise poses by providing a correct pose. In another example, intelligent cameras employing the conventional pose modification techniques may automatically capture an image based on a good pose by referring to facial expressions of users. Further, the conventional pose modification techniques may also recommend the pose based on a location of the image being captured. In addition to the conventional pose modification techniques, pose transfer methods are widely used to change or modify the pose of the user. Each of conventional pose modification techniques and the pose transfer methods change or modify the pose of the users by using a reference pose as an input. In a non-limiting example, the pose transfer methods are used by online commercial platforms for changing or modifying the pose of a user (model) by using the reference pose. The pose transfer methods may also be used for transferring pose of models for branding and cloth/clothes commercialization. The reference pose used by the pose transfer methods is either taken from pictures captured by photographers, from a database, or from social media platforms which limits application of such conventional pose modification techniques and pose transfer methods for all use-case scenarios. Also, it is incredibly challenging, if at all, for the conventional pose modification techniques to generate an appealing and natural pose due to the compulsory requirement of the reference pose as the input. Furthermore, the conventional pose modification techniques have a plurality of limitations and disadvantages such as the properties of surroundings of the user are not being considered resulting while generating the reference pose, and thus result in an inaccurate and irrelevant pose. Another limitation is the absence of editing options related to pose modification or changing an object movement.

Accordingly, there lies a need for an improved technique and method that can overcome the above-identified problems and limitations associated with the conventional techniques and method for the pose modification.

### SUMMARY

This summary is provided to introduce a selection of concepts, in a simplified format, that are further described in the detailed description of the invention. This summary is neither intended to identify key or essential inventive concepts of the invention nor is it intended for determining the scope of the invention.

There is provided a system and method for modifying an input user pose from an input image, the system including and the method using: a memory; one or more processors communicably coupled to the memory, the one or more processors are configured to: extract, from the input image, a plurality of features associated with at least one user and at least one object; determine, based on the extracted plurality of features and one or more contexts predetermined as associated with the at least one object, one or more possible user interactions with the at least one object; determine, based on the determined one or more possible user interactions, the extracted plurality of features, and a joint-to-joint correlation, a joint-object score representing a relation between a user body joint, amongst a plurality of user body joints of the at least one user, and the at least one object; generate, based on the determined joint-object score, a set of user poses corresponding to the at least one user; determine, based on the determined joint-object score and one or more points of interest in the input image, a containment score associated with each user pose of the generated set of user poses; determine, based on the determined containment score and as an optimal user pose, one of the user poses amongst the generated set of user poses; and modify, in the input image and based on the determined optimal user pose, the input user pose and an object orientation associated with the at least one object.

Extracting the plurality of features may include: determining the plurality of user body joints of the at least one user, wherein the plurality of user body joints collectively represents the input user pose from the input image; and generating a three-dimensional (3D) model and a set of surface areas of the at least one object.

Extracting the plurality of features may include determining, based on the generated 3D model and the generated set of surface areas, the one or more contexts.

Generating the set of user poses may include: determining a plurality of surface points on each surface area of the set of surface areas; modifying, based on a relation associated with a distance between the plurality of user body joints and the at least one object, one or more positions of the plurality of user body joints in the input image, the relation is based on the determined joint-object score, the determined plurality of surface points, and one or more predefined articulation parameters associated with the user pose; and generating, further based on modifying the one or more positions of the plurality of user body joints in the input image, the set of user poses.

The relation associated with the distance between the plurality of user body joints and the at least one object may be further based on one of minimizing and maximizing the distance between the plurality of user body joints and the at least one object.

The input image may represent at least one of a two-dimensional (2D) image, a three-dimensional (3D) image, a video frame, an Augmented Reality (AR) image, and a Virtual Reality (VR) image.

Determining the containment score may include: determining, for said each user pose of the generated set of user poses, the one or more points of interest in the input image, wherein the one or more points of interest in the input image are estimated to be of interest to the at least one user, are points that are located on the at least one object, and correspond to a direction of motion of the at least one user, and wherein the points that are located on the at least one object are determined to have a higher probability of being interacted with by the at least one user than other points from the input image; identifying one or more regions around the determined one or more points of interest; and generating, based on a distance between the identified one or more regions and the one or more points of interests, a region score of each of the identified one or more regions.

Extracting the plurality of features may include: performing an input image segmentation process including dividing the input image into a plurality of image segments; predicting one or more image parameters of each of the plurality of image segments, wherein the predicted one or more image parameters comprise at least one of an object class, an object box offset, and a binary mask; masking out, based on a set of segmentation masks and the predicted one or more image parameters, a set of objects and the at least one user from the input image; identifying, based on a result of masking out the set of objects and the at least one user from the input image, the at least one user; and identifying, based on the masking out of the set of objects from the input image, the at least one object.

Determining the joint-object score may include: determining, based on a relation of each of the plurality of user body joints with the at least one object, a joint interaction score for each of the plurality of user body joints; determining the joint-to-joint correlation of a user body joint, of the plurality of user body joints, with respect to other user body joints amongst the plurality of user body joints; and determining the joint-object score further based on the determined joint interaction score and the determined joint-to-joint correlation.

The one or more processors may be further configured to: identify, in the input image and based on modifying the input user pose, one or more exposed spaces and one or more hidden spaces upon modifying, in the input image, the input user pose and the object orientation; and perform an image in-painting operation on the input image, the image in-painting operation including reconstructing the identified one or more exposed spaces and the identified one or more hidden spaces.

The one or more processors may be further configured to: identify, based on the at least one object and one or more surrounding scenes in the input image, a context type of the input image; and determine, based on the determined containment score and the identified context type, the optimal user pose amongst the generated set of user poses.

The one or more processors may be further configured to determine, based on one or more object parameters, a priority of the at least one object, wherein the one or more object parameters represent parameters of any of a distance relationship between the at least one user and the at least one object in the input image, an object type of the at least one object, the object orientation, and the user pose, and generating the set of user poses corresponding to the at least one user is further based on the determined priority.

The one or more processors may be further configured to receive at least one user input to prioritize the at least one object in generating the set of user poses, and generating the set of user poses corresponding to the at least one user is further based on the received at least one user input.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a block diagram of a system for modifying a user pose in an input image, according to one or more embodiments of the present disclosure;

FIG. 2 illustrates a schematic representation depicting the working of a surrounding object determiner to extract a set of features from the input image, according to one or more embodiments of the present disclosure;

FIG. 3A is a schematic representation for detecting a pose of at least one user, according to one or more embodiments of the present disclosure;

FIG. 3B is a pictorial representation of an exemplary key joint topology of a human pose, according to one or more embodiments of the present disclosure;

FIG. 3C is a schematic representation for converting 2D body joint coordinates of a user into 3D Cartesian coordinates, according to one or more embodiments of the present disclosure;

FIG. 3D is a schematic representation depicting a 3D space in which a 3D pose of the user is detected, according to one or more embodiments of the present disclosure;

FIG. 3E illustrates a schematic representation for determining a 3D pose of the user, according to one or more embodiments of the present disclosure;

FIG. 4A illustrates a schematic representation for converting a 2D object into a 3D object, according to one or more embodiments of the present disclosure; and

FIG. 4B illustrates a schematic representation depicting the working of an object 3D modeler for generating a 3D model and a set of surface areas associated with at least one object, according to one or more embodiments of the present disclosure;

FIG. 5 illustrates a schematic representation depicting the working of a context determiner for determining one or more possible user interactions, according to one or more embodiments of the present disclosure;

FIG. 6A illustrates a block diagram depicting an architecture of a DNN model for generating a joint-interaction relation, according to one or more embodiments of the present disclosure;

FIG. 6B illustrates a pictorial depiction of a joint-to-joint correlation, according to one or more embodiments of the present disclosure;

FIG. 6C illustrates a pictorial depiction representing a process of generating a joint-object score, according to one or more embodiments of the present disclosure;

FIG. 6D illustrates a schematic representation depicting the process of generating the joint-object score, according to one or more embodiments of the present disclosure;

FIG. 7A illustrates a pictorial depiction showing a plurality of surface points on the at least one object, according to one or more embodiments of the present disclosure;

FIG. 7B illustrates a schematic representation depicting the process of working of a pose combination generator to generate a set of user poses, according to one or more embodiments of the present disclosure;

FIG. 7C, FIG. 7D, and FIG. 7E each illustrate a respective pictorial depiction for generating the set of user poses, according to one or more embodiments of the present disclosure;

FIG. 8A illustrates a pictorial depiction showing one or more points of interest in image space, according to one or more embodiments of the present disclosure;

FIG. 8B illustrates a schematic representation depicting determination of the user's motion points, according to one or more embodiments of the present disclosure;

FIG. 8C illustrates a schematic representation depicting an object-centric attention network, according to one or more embodiments of the present disclosure;

FIG. 8D illustrates a schematic representation depicting the working of a point(s) of interest determiner for determining one or more points of interest, according to one or more embodiments of the present disclosure;

FIG. 8E illustrates a pictorial depiction showing region scores around the one or more points of interest, according to one or more embodiments of the present disclosure;

FIG. 8F illustrates a schematic representation depicting the working of a containment score determiner, according to one or more embodiments of the present disclosure;

FIG. 8G illustrates a schematic representation depicting prioritization of the set of poses, according to one or more embodiments of the present disclosure;

FIGS. 9A and 9B illustrate schematic representations depicting the working of a pose renderer, according to one or more embodiments of the present disclosure;

FIGS. 9C and 9D illustrate schematic representations depicting the working of an image in-painter, according to one or more embodiments of the present disclosure;

FIG. 10 illustrates a block diagram of an exemplary system for modifying the user pose in the input image, according to another one or more embodiments of the present disclosure;

FIG. 11 illustrates a block diagram of an exemplary system for modifying the user pose in the input image, according to yet another one or more embodiments of the present disclosure;

FIG. 12 illustrates a block diagram of an exemplary system for modifying the user pose in the input image, according to another one or more embodiments of the present disclosure;

FIG. 13 illustrates a block diagram of an exemplary system for modifying the user pose in the input image, according to yet another one or more embodiments of the present disclosure;

FIG. 14 illustrates a process flow diagram depicting an operation of the system for modifying the user pose in the input image, according to one or more embodiments of the present disclosure;

FIG. 15A, FIG. 15B, FIG. 15C, FIG. 15D, and FIG. 15E illustrate pictorial depictions showing use-case scenarios of the system for modifying the user pose in the input image, according to one or more embodiments of the present disclosure; and

FIG. 16 illustrates a process flow diagram depicting a method for modifying the user pose in the input image, according to one or more embodiments of the present disclosure.

Further, skilled artisans will appreciate that those elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

For the purpose of promoting an understanding of the principles of the invention, reference will now be made to the various embodiments and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one or more embodiments of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components preceded by “comprises . . . a” does not, without more constraints, preclude the existence of other devices or other sub-systems or other elements or other structures or other components or additional devices or additional sub-systems or additional elements or additional structures or additional components.

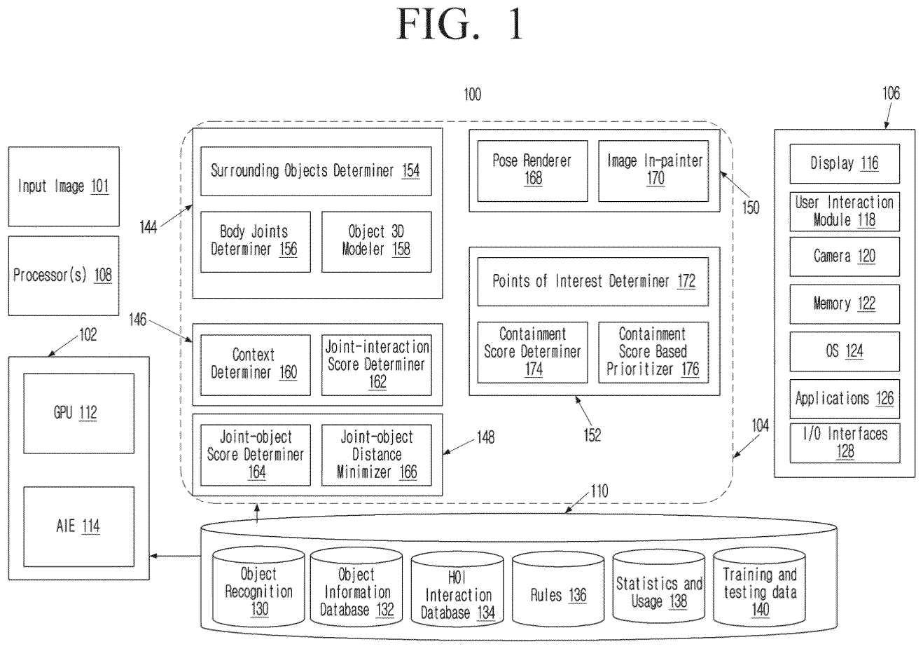

FIG. 1 illustrates a block diagram of a system 100 for modifying a user pose in an input image 101, according to one or more embodiments of the present disclosure. In one or more embodiments of the present disclosure, the pose represents a position and an orientation of the user, usually in three dimensions. Further, the system 100 is implemented in an electronic device. Examples of the electronic device may include but are not limited to, a smartphone, a laptop, a camera device, a smartwatch, and the like.

The system 100 may include an on-device acceleration 102 (compute), a plurality of modules 104, a media device 106, one or more processors 108 (controllers), and a database 110.

In one or more embodiments of the present disclosure, the on-device acceleration 102 includes a Graphical Processing Unit (GPU) 112 and Artificial Intelligence Engine (AIE) 114. The GPU 112 is a specialized electronic circuitry or chip designed to handle and accelerate the processing of computer graphics and visual data. It is an essential component of modern computer systems and is primarily used for rendering images, videos, and animations in real-time. Further, the AIE 114 refers to the core component or the system 100 that powers an AI application or service. The AIE 114 is responsible for executing the algorithms, models, and techniques that enable artificial intelligence capabilities, such as machine learning, natural language processing, computer vision, and the like.

Further, the media device 106 includes a set of components, such as a display 116, a user interaction module 118, a camera 120, a memory 122, an Operation System (OS) 124, applications 126, and Input/Output (I/O) interfaces 128, and the like. The display 116 corresponds to an output device that allows users to view text, images, videos, and other graphical content produced by the system 100. Further, the user interaction module 118 facilitates communication and interaction between the user and the system 100. For example, in the current embodiment, the user may provide the input image 101 to the user as an input to the system 100 for modifying the user pose in the input image 101. In one or more embodiments of the present disclosure, the camera 120 is configured to capture the input image 101.

In an exemplary embodiment, the one or more processor(s) 108 (controllers)processor(s) 108 (controllers) may be operatively coupled to each of the media device 106 and the plurality of modules 104. In one or more embodiments, the one or more processor(s) 108 (controllers)processor(s) 108 (controllers) may include at least one data processor for executing processes in Virtual Storage Area Network (VSAN). The one or more processor(s) 108 (controllers)processor(s) 108 (controllers) may include specialized processing units such as integrated system (bus) controllers, memory management control units, floating point units, graphics processing units, digital signal processing units, etc. In one or more embodiments, the one or more processor(s) 108 (controllers)processor(s) 108 (controllers) may include a Central Processing Unit (CPU), the GPU 112, or both. The one or more processor(s) 108 (controllers)processor(s) 108 (controllers) may be one or more general processors, digital signal processors, application-specific integrated circuits, field-programmable gate arrays, servers, networks, digital circuits, analog circuits, combinations thereof, or other now known or later developed devices for analyzing and processing data. The one or more processor(s) 108 (controllers)processor(s) 108 (controllers) may execute a software program, such as code generated manually (i.e., programmed) to perform the desired operation. In one or more embodiments of the present disclosure, the processor(s) 108 (controllers)processor(s) 108 (controllers) may be a general-purpose processor, such as the CPU, an Application Processor (AP), or the like, a graphics-only processing unit such as the GPU 112, a Visual Processing Unit (VPU), and/or an AI-dedicated processor, such as a Neural Processing Unit (NPU).

Further, the one or more processor(s) 108 (controllers)processor(s) 108 (controllers) control the processing of input data in accordance with a predefined operating rule or machine learning (ML) model stored in the non-volatile memory and the volatile memory. The predefined operating rule or the ML model is provided through training or learning.

Here, being provided through learning means that, by applying a learning technique to a plurality of learning data, a predefined operating rule or the ML model of a desired characteristic is made. The learning may be performed in a device itself in which ML according to one or more embodiments is performed, and/or may be implemented through a separate server/system.

Furthermore, the ML model may consist of a plurality of neural network layers. Each layer has a plurality of weight values and performs a layer operation through a calculation of a previous layer and an operation of a plurality of weights. Examples of neural networks include but are not limited to, Convolutional Neural Networks (CNN), Deep Neural Networks (DNN), Recurrent Neural Networks (RNN), Restricted Boltzmann Machine (RBM), Deep Belief Networks (DBN), Bidirectional Recurrent Deep Neural Network (BRDNN), Generative Adversarial Networks (GAN), and deep Q-network.

The learning technique is a method for training a predetermined target device (for example, a robot) using a plurality of learning data to cause, allow, or control the target device to make a determination or prediction. Examples of learning techniques include but are not limited to supervised learning, unsupervised learning, semi-supervised learning, or reinforcement learning.

The one or more processor(s) 108 (controllers)processor(s) 108 (controllers) may be disposed in communication with one or more input/output (I/O) devices via the I/O interfaces 128. The I/O interfaces 128 may employ communication code-division multiple access (CDMA), high-speed packet access (HSPA+), global system for mobile communications (GSM), long-term evolution (LTE), WiMax, or the like, etc.

The one or more processor(s) 108 (controllers)processor(s) 108 (controllers) may be disposed in communication with a network via a network interface. In an embodiment, the network interface may be the I/O interfaces 128. The network interface may connect to the network to enable the connection of the electronic device with other electronic devices. The network interface may employ connection protocols including, without limitation, direct connect, Ethernet (e.g., twisted pair 10/100/1000 Base T), transmission control protocol/internet protocol (TCP/IP), token ring, IEEE 802.11 a/b/g/n/x, etc. The network may include, without limitation, a direct interconnection, local area network (LAN), wide area network (WAN), wireless network (e.g., using Wireless Application Protocol), the Internet, and the like.

In one or more embodiments of the present disclosure, the one or more processor(s) 108 processor(s) 108 are configured to extract, from the input image 101, a plurality of features associated with at least one user and at least one object in proximity to the user. The one or more processor(s) 108 processor(s) 108 are also configured to determine one or more possible user interactions with the at least one object based on the extracted plurality of features and one or more contexts associated with the at least one object. Further, the one or more processor(s) 108 processor(s) 108 are configured to determine, based on the determined one or more possible user interactions, the extracted plurality of features, and a joint-to-joint correlation, a joint-object score corresponding to a relation between a corresponding user body joint amongst a plurality of user body joints and the at least one object. The one or more processor(s) 108 processor(s) 108 are configured to generate a set of user poses corresponding to the at least one user based on the determined joint-object score. Furthermore, the one or more processor(s) 108 processor(s) 108 are configured to determine a containment score associated with each of the generated set of user poses based on the determined joint-object score and one or more points of interest in the input image 101. The one or more processor(s) 108 processor(s) 108 are configured to determine an optimal user pose amongst the generated set of user poses based on the determined containment score. The one or more processor(s) 108 processor(s) 108 are also configured to modify the user pose associated with the at least one user and an object orientation associated with the at least one object in the input image 101 in context with the determined optimal user pose.

In some embodiments, the memory 122 may be communicatively coupled to the one or more processor(s) 108 (controllers). The memory 122 may be configured to store data, and instructions executable by the one or more processor(s) 108 (controllers). The memory 122 may include but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 122 may include a cache or random-access memory for the one or more processor(s) 108 (controllers). In alternative examples, the memory 122 is a part of the one or more processor(s) 108 (controllers), such as a cache memory of a processor, the system memory, or other memory. In some embodiments, the memory 122 may be an external storage device or database for storing data. The memory 122 may be operable to store instructions executable by the one or more processor(s) 108 (controllers). The functions, acts, or tasks illustrated in the figures or described may be performed by the programmed processor/controller for executing the instructions stored in the memory 122. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like.

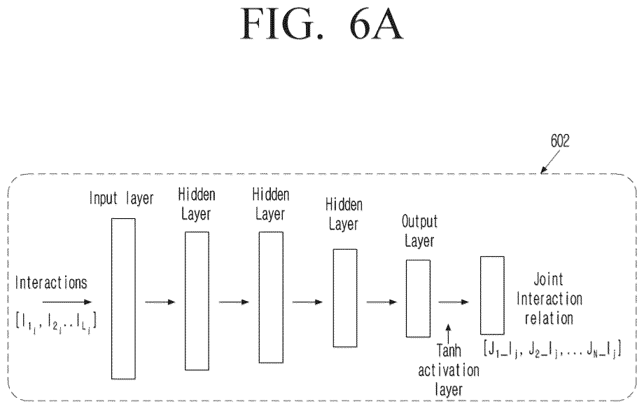

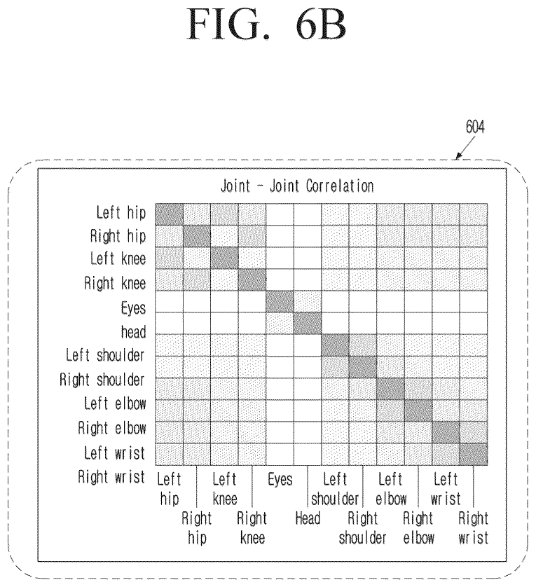

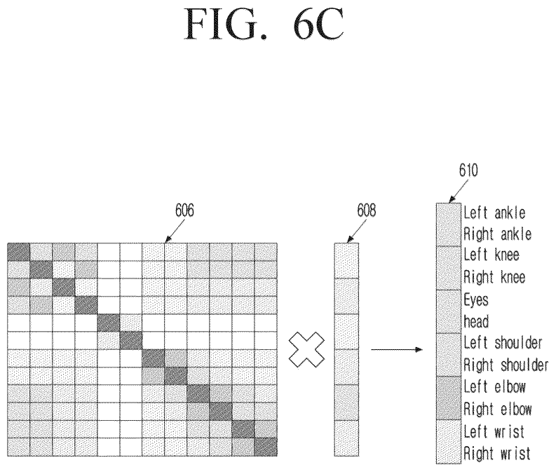

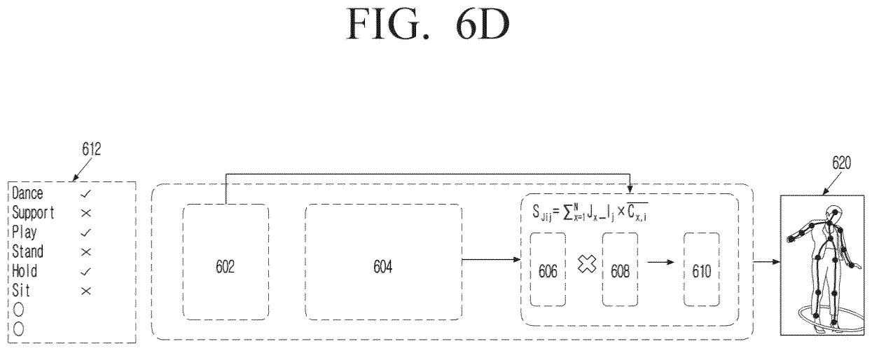

In some embodiments, the plurality of modules 104 may be included within the memory 122. The plurality of modules 104 may include a set of instructions that may be executed to cause the system 100 to perform any one or more of the methods/processes disclosed herein. The system 100 may also include a database/knowledgebase 110 for storing data associated with object recognition 130, object information database 132, Human Object Interaction (HOI) interaction database 134, rules 136, statistics and usage 138, and training and testing data 140. In one or more embodiments of the present disclosure, the data associated with the object recognition 130 corresponds to techniques used for object recognition from the input image 101. Further, the object information database 132 is used to train the object recognition deep learning models. The object information database 132 includes the data associated with bounding boxes of each object and also their centroids in the images. Further, the HOI interaction database 134 includes HOIs. For example: Hula loop is used to play, dance, hold, and the like (these are the types of interactions that are possible with hula loop). Furthermore, rules 136 correspond to generic rules, such as articulation is required to be maintained when the joints are moved for pose combination generation. The statistics and usage 138 correspond to the statistics of the metric, such as memory usage, CPU usage of the system 100, and the like. The training and testing data 140 represent processed HOI data that is required to train the deep learning model (as represented by architecture 602 in FIG. 6A). The plurality of modules 104 may be configured to perform the steps of the present disclosure using the data stored in the database/knowledgebase 110 for modifying the user pose in the input image 101, as discussed herein. In an embodiment, each of the plurality of modules 104 may be a hardware unit that may be outside the memory 122. Further, the memory 122 may use the OS for performing one or more tasks of the system 100, as performed by a generic operating system in the communications domain. In one or more embodiments, the database 110 may be configured to store the information as required by the plurality of modules 104 and the one or more processor(s) 108 (controllers)processor(s) 108 (controllers) for modifying the user pose in the input image 101. In an exemplary embodiment of the present disclosure, the input image 101 corresponds to a two-dimensional (2D) image, a three-dimensional (3D) image, a video frame, an Augmented Reality (AR) image, or a Virtual Reality (VR) image.

In one or more embodiments of the present disclosure, at least one of the plurality of modules 104 may be implemented through the ML model. A function associated with the ML may be performed through the non-volatile memory, the volatile memory, and the one or more processor(s) 108.

In an embodiment, the I/O interfaces 128 may enable input and output to and from the system 100 using suitable devices such as, but not limited to, a display, a keyboard, a mouse, a touch screen, a microphone, a speaker, and so forth.

Further, the present invention also contemplates a computer-readable medium that includes instructions or receives and executes instructions responsive to a propagated signal. Further, the instructions may be transmitted or received over the network via a communication port or interface or using a bus. The communication port or interface may be a part of the one or more processor(s) 108 (controllers)processor(s) 108 (controllers) or may be a separate component. The communication port may be created in software or may be a physical connection in hardware. The communication port may be configured to connect with a network, external media, the display 116, or any other components in the electronic device, or combinations thereof. The connection with the network may be a physical connection, such as a wired Ethernet connection, or may be established wirelessly. Likewise, the additional connections with other components of the electronic device may be physical or may be established wirelessly. The network may alternatively be directly connected to the bus. For the sake of brevity, the architecture and standard operations of the OS 124, the memory 122, the database 110, the one or more processor(s) 108, and the I/O interfaces 128 are not discussed in detail.

In one or more embodiments of the present disclosure, the plurality of modules 104 may include, but is not limited to, an image feature extractor 144, an interaction determiner 146, a pose combination generator 148, a pose prioritizer 152, and an image reconstructor 150. The plurality of modules 104 may be implemented by way of suitable hardware and/or software applications 126. Further, the image feature extractor 144 includes a set of sub-modules, such as a surrounding objects determiner 154, a body joints determiner 156, and an object Three Dimension (3D) modeler 158. Furthermore, the interaction determiner 146 includes a set of sub-modules, such as a context determiner 160 and a joint-interaction score determiner 162. The pose combination generator 148 includes a set of sub-modules, such as a joint-object score determiner 164 and a joint-object distance minimizer 166. The pose prioritizer 152 also includes a set of sub-modules, such as a point(s) of interest determiner 172, a containment score determiner 174, and a containment score-based prioritizer 176. Further, the image reconstructor 150 includes a set of sub-modules, such as a pose renderer 168 and an image in-painter 170.

In one or more embodiments of the present disclosure, the image feature extractor 144 may be configured to extract, from the input image 101, the plurality of features associated with the at least one user and the at least one object in proximity to the user. In an exemplary embodiment of the present disclosure, the plurality of features corresponds to a plurality of user body joints of the at least one user, the at least one object in proximity to the user, a 3D model, and a set of surface areas associated with the at least one object. For example, the at least one object may be an entity or element that is present in the input image 101, such as vehicles, buildings, household items, natural elements (trees and mountains), animals, and the like.

In extracting the plurality of features, the surrounding objects determiner 154 may be configured to determine the at least one object in the input image 101 by performing image segmentation on the input image 101 to locate the at least one object. In one or more embodiments of the present disclosure, the surrounding objects determiner 154 may be configured to perform an input image 101 segmentation process to divide the input image 101 into a plurality of image segments. In an exemplary embodiment of the present disclosure, the image segmentation is implemented using a mask Region-based Convolutional Neural Network (R-CNN) which is similar to a faster R-CNN. Further, the surrounding objects determiner 154 may be configured to predict one or more image parameters for each of the plurality of image segments. In an exemplary embodiment of the present disclosure, the predicted one or more image parameters include an object class, an object box offset, a binary mask, or any combination thereof. For example, when the input image 101 includes the user and a hula-hoop, the output of the image segmentation process is object class as human and hula-hoop with the bounding boxes of each image segment. In one or more embodiments of the present disclosure, the surrounding objects determiner 154 performs an image classification operation on the located at least one objects, such that the at least one objects are then represented as a type of the at least one object (e.g., hula-hoop) and centroid of the at least one object's bounding box.

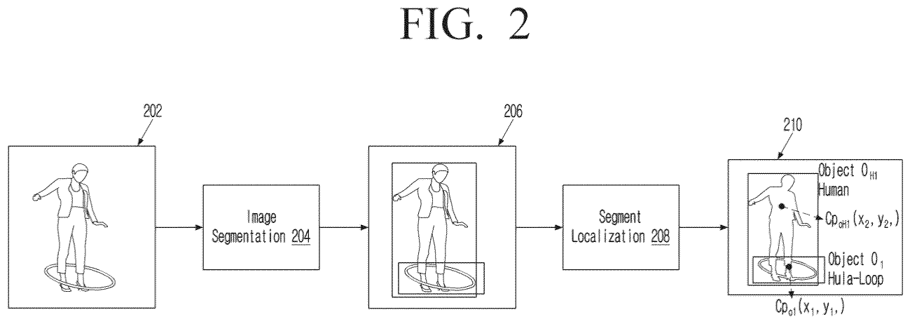

Further, the surrounding objects determiner 154 may be configured to mask out a set of objects and the at least one user from the input image 101 using a set of segmentation masks and the predicted one or more image parameters upon identifying the object classes [, . . . CN] and the plurality of image segments. Furthermore, the surrounding objects determiner 154 may be configured to identify the at least one user in focus based on a result of masking out the set of objects and the at least one user from the input image 101. The surrounding objects determiner 154 may also be configured to identify the at least one object that is in proximity to the at least one user in focus based on the masking out of the set of objects from the input image 101. In one or more embodiments of the present disclosure, the objects which are in proximity to the user are taken into consideration. The range of proximity is a constant distance R. For example, objects that are segmented are further classified as human objects [O_{H1}, . . . O_{HN}] and non-human objects [O₁, O₂, . . . Oₖ]. The non-human objects [O₁, O₂, . . . , Oₖ] are referred to as the at least one object, where K is the number of at least one object; given K≥1. Further, an example of the working of the surrounding object determiner to extract the set of features from the input image 101 is explained in detail with reference to at least FIG. 2.

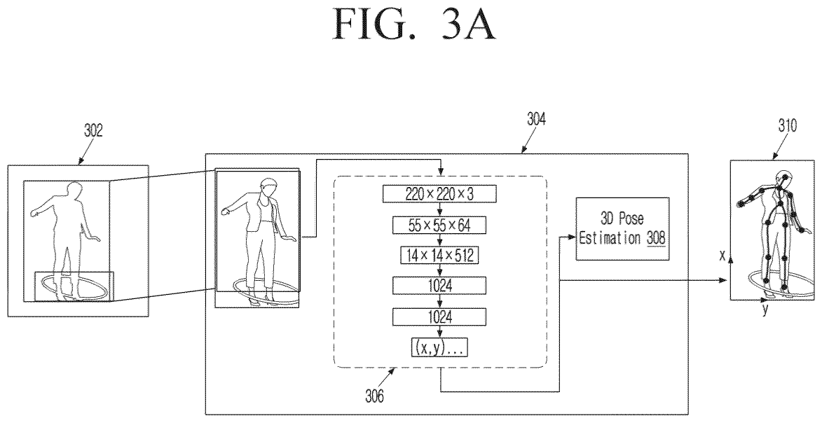

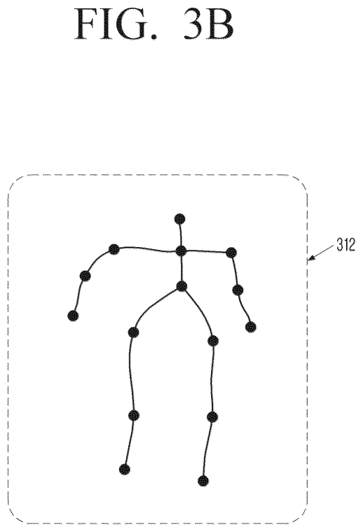

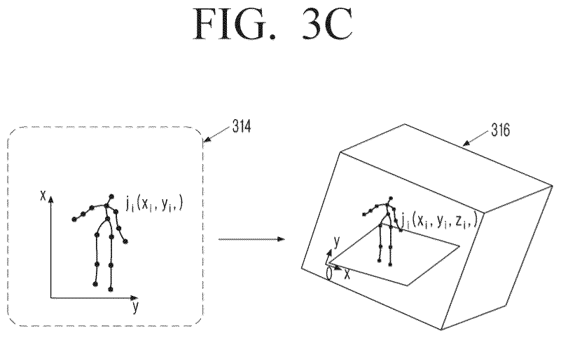

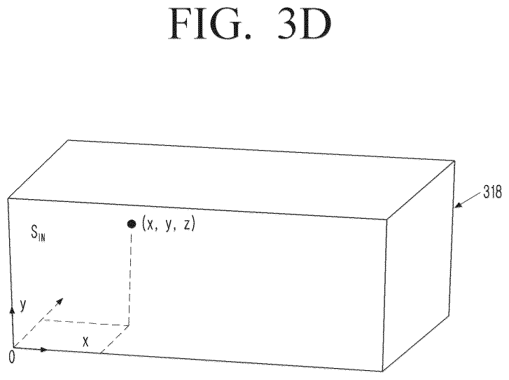

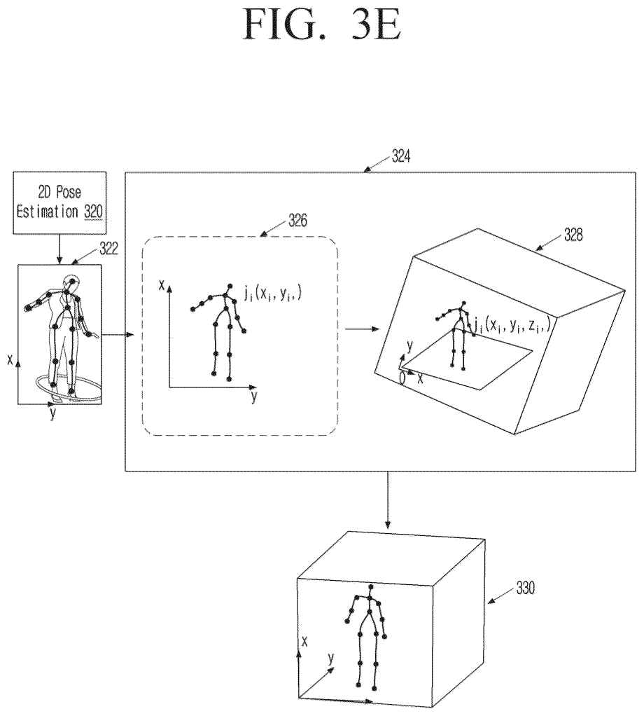

Further, the body joints determiner 156 determines the plurality of user body joints of the at least one user. In one or more embodiments of the present disclosure, the plurality of user body joints together represents the user pose of the at least one user in the input image 101. The body joints determiner 156 processes the plurality of segments of the input image 101 corresponding to human [O_{H1}, . . . O_{HN}] to detect the pose of the at least one user in focus using CNN. An example of detecting the pose of the at least user is explained with reference to at least FIG. 3A. Further, a CNN-based regressor that uses a fully connected network is used to determine the plurality of body joints of the at least one user [j₁, j₁, . . . j_{N}], where jᵢ(xᵢ, yᵢ) represents the 2D Cartesian coordinate of i body joint of the at least one user, and N is the total number of movable body joints of the human pose. In one or more embodiments of the present disclosure, the pose of the at least one user in the input image 101 is determined in terms of the key joints topology. The key joints are the body joints of the human skeleton, such as elbow, knee, and the like. In one or more embodiments of the present disclosure, the 2D key-point topology is converted into a 3D pose coordinate system. An example of the key joint topology of a human pose is shown in FIG. 3B.

Furthermore, the 2D body joint coordinates [j₁, j₁, . . . , j_{N}], obtained from pose detection are further processed to find the corresponding 3D body joint coordinates [J₁, J₁, . . . , J_{N}]. In one or more embodiments of the present disclosure, the joint determiner estimates the 3D pose coordinates by using a simple Deep Neural Network (DNN) with residual connections trained on a Human 3.6 M dataset. For every 2D body joints coordinate, a 3D Cartesian coordinate of the body joint associated with the human pose is determined. An example of converting the 2D body joint coordinates into the 3D Cartesian coordinate is explained with reference to at least FIG. 3C. Thus, the input image in 2D space is now converted into a 3D space as a result of converting the 2D body joint coordinates into the 3D Cartesian coordinate. An example of the 3D space is shown in FIG. 3D. Further, an example of determining the 3D pose of the user is explained with reference to at least FIG. 3E.

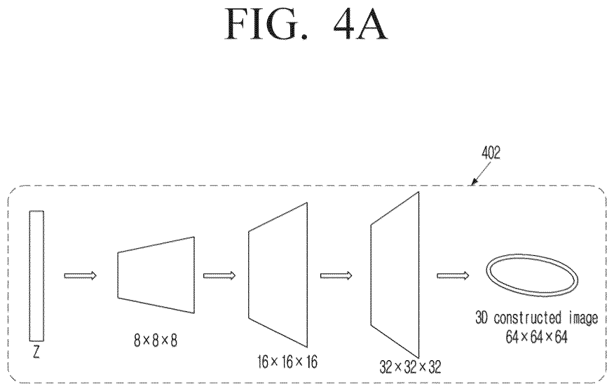

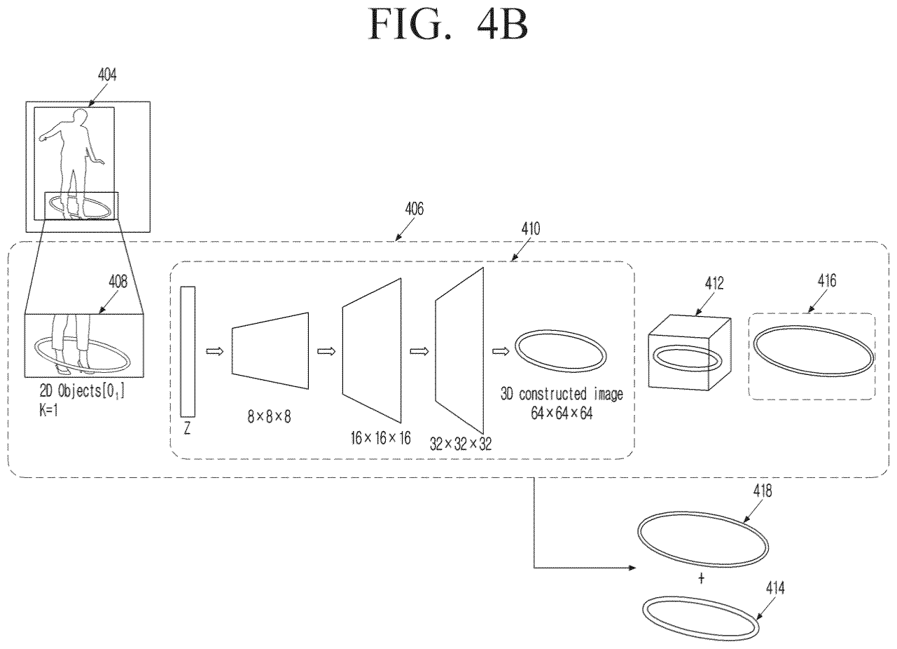

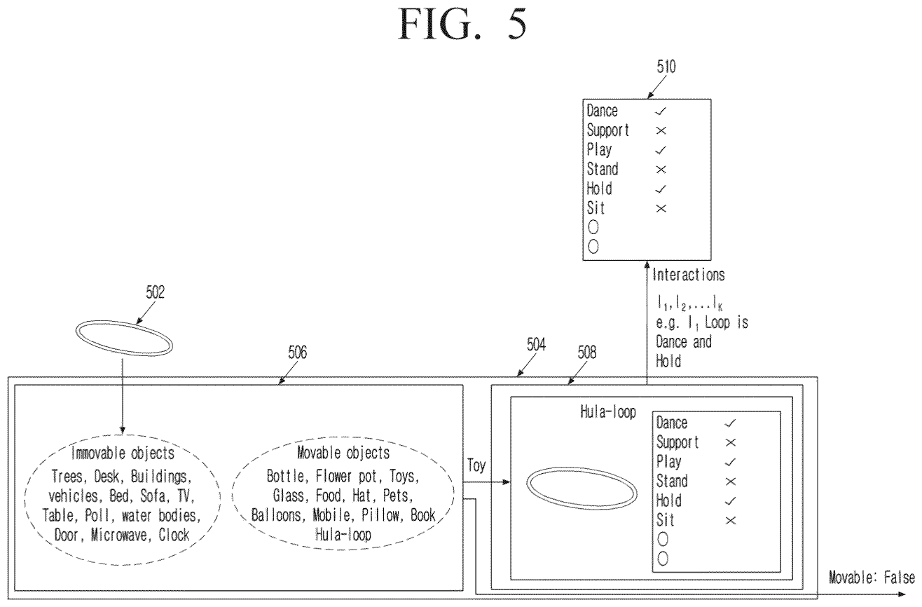

Further, the object 3D modeler 158 may be configured to perform 3D object modeling for generating a 3D model and a set of surface areas associated with the at least one object. In one or more embodiments of the present disclosure, the 3D object modeling is required for generating accurate pose combinations. The 3D object modeling involves two steps i.e., object construction and object surface estimation. In one or more embodiments of the present disclosure, the object construction involves converting a 2D object into a 3D object. In an exemplary embodiment of the present disclosure, the 2D object is converted into the 3D object by using a 3D Generative Adversarial Network (GAN). In one or more embodiments of the present disclosure, the updated centroid of the 3D object is Cpₒᵢ={xₒᵢ, yₒᵢ, zₒᵢ}, where xₒᵢ and yₒᵢ are taken from the pₒᵢ (centroid of the object determined using the box offset) and zₒᵢ is same as the z coordinate of the user's centroid position. Further, an example of converting the 2D object into the 3D object is explained with reference to at least FIG. 4A.

Further, the set of surface areas of the at least one object are estimated upon generating the 3D model of the at least one object. The interaction of the at least one user with the at least one object is likely with the surfaces of the at least one object. Thus, it is important to estimate the surfaces of all the objects present in the image space. The set of surface areas are estimated by the object 3D modeler 158, such that both planar surfaces and curved surfaces associated with the at least one object are detected. Further, the working of the object 3D modeler 158 is explained with reference to at least FIG. 4B.

Furthermore, the interaction determiner 146 may be configured to determine one or more possible user interactions with the at least one object based on the extracted plurality of features and one or more contexts associated with the at least one object. In determining the one or more possible user interactions, the context determiner 160 determines the one or more contexts associated with the at least one object based on the generated 3D model and the generated set of surface areas. In one or more embodiments of the present disclosure, the one or more contexts correspond to information in terms of movability of the at least one object, such as movable or immovable objects. For example, an immovable class of objects includes objects whose position cannot be modified, such as trees, buildings, desks, and the like. For example, a movable class of objects includes objects whose position can be modified, such as hula-hoop, toy, pet, bouquet, and the like. Furthermore, the one or more contexts also include a classification of categories, such as toy, furniture, environment, and the like. For example, the object hula-hoop comes under a toy context.

In one or more embodiments of the present disclosure, the one or more possible user interactions are most probable human-object actions that may occur with the at least one object. For example, the one or more possible user interactions that are aligned with the object furniture are head rest, sleep, sit, and the like. In another example, the one or more interactions associated with the object hula hoop whose context is toy are play, hold, dance, and the like. In one or more embodiments of the present disclosure, the context determiner 160 determines the one or more possible users {[I₁₁, I₂₁, . . . , I_{L1}], . . . , [I_{1K}, I_{2K}, . . . , I_{LK}]} based on the determined one or more contexts and by using a Humans Interacting with Common Objects (HICO) dataset. I_{LK} represents the joint-object score of body joint jN associated with kth object. L defines the total number of possible user interactions as per the HICO dataset. In one or more embodiments of the present disclosure, the HICO dataset has every object mapped with the interaction associated with the object. Further, the working of the context determiner 160 is explained with reference to at least FIG. 5.

Further, the pose combination generator 148 may be configured to generate a set of user poses (P₁, P₂, . . . , P_{M}) corresponding to the at least one user from the at least one object. In one or more embodiments of the present disclosure, the set of poses are generated by minimizing a distance between the plurality of the user body joints of the at least one user and the at least one object based on the joint-object scores. In generating the set of user poses, the joint-object score determiner 164 determines, based on the determined one or more possible user interactions, the extracted plurality of features, and a joint-to-joint correlation, a joint-object score corresponding to a relation between a corresponding user body joint amongst a plurality of user body joints and the at least one object. In one or more embodiments of the present disclosure, the joint-object scores [(Sⱼ₁1, . . . S_{jN}1), . . . (S_{j1K}, . . . S_{jN}K)] of K objects correspond to a score of a joint's interaction with the at least one object scaled according to the joint-joint correlation. S_{jN}K represents the joint-object score of body joint jN associated with the kth object. The joint-object scores are used to find the relation between the plurality of user body joints of the at least one user and the at least one object. In one or more embodiments of the present disclosure, the joint-interaction relations of surrounding object Oⱼ and the plurality of user body joints (J₁, J₂, . . . , J_{N}) are denoted as (Jᵢ₁_Iⱼ, J₂_Iⱼ, . . . , J_{N}_Iⱼ), where J₁_Iⱼ is the interaction relation associated with joint Jᵢ and object Oⱼ, ∀ i≤N, j≤K. Further, to determine the joint-interaction relation, a DNN model is trained. The DNN model is trained using a hand-labeled dataset or via human feedback based on the joint involvement for a given interaction. In one or more embodiments of the present disclosure, a rough hand-labeled dataset is sufficient to get the desired results. Further, a joint-interaction probability score is normalized using a normalization technique, such that J₁_Iⱼ varies from −1 to 1. In one or more embodiments of the present disclosure, the normalization from −1 to 1 is necessary to give a negative weight to the user joints which are not involved in the interaction. For example, the normalization technique may be tanh activation layer. This will be useful for a combination generation and prioritization step. In one or more embodiments of the present disclosure, the equation of architecture of the DNN model is as follows:

$${Output}_{b} = \sum {Input}_{a} * {w}_{ab} ; \qquad Eq . ( 1 )$$

$$∀ 0 \leq a \leq A , 0 \underline{<} b \leq B$$

In one or more embodiments of the present disclosure, A is a number of input neurons in a hidden layer, B is the number of output neurons in a hidden layer, Output_{b} is the b^{th} output of the layer, Inputₐ is the a^{th} input of the layer, and w is the weight matrix with A rows and B rows. Further, the architecture of the DNN model is explained with reference to at least FIG. 6A.

In one or more embodiments of the present disclosure, the joint interaction score determiner 162 determines joint interaction scores for each of the plurality of user body joints based on a relation of each of the plurality of user body joints with the at least one object. Further, the joint-object score determiner 164 determines the joint-to-joint correlation of the corresponding user body joint with respect to the other user body joints amongst the plurality of user body joints based on the predefined rules corresponding to each of the user body joints. For example, for an input interaction of hold or hand rest, the user body joints corresponding to the hands are assigned a higher probability (e.g. J_I score=1), whereas the user body joints corresponding to the legs are assigned a lower probability (e.g. J_I score=−1) as the legs are not at all involved in the interaction of hold or hand rest. Further, the joint-to-joint correlation is depicted in FIG. 6B.

In one or more embodiments of the present disclosure, joint-interaction scores may not be used directly for further processing. There may be a correlation between nearby body joints of the user which may not have been considered in the determination of the joint-interaction scores. For example, when a person is running, the movement of the wrists and elbows of the right hand is highly correlated with the movement of the knees and foot of the left leg. Thus, it is important to re-enforce the joint-joint correlation to determine a joint-object score from the joint-interaction score. In one or more embodiments of the present disclosure, a joint-joint correlation, Ci, is defined as the correlation between body joint Ji and body joint Ij, such that 0≤Cij≤1 ∀ 0≤i,≤N. The Joint-Joint correlation is determined by estimating the temporal relation between the joints. An averaged joint-joint correlation, C̅i̅,̅J̅ is determined by determining the Joint-Joint correlation, Ci,j on a defined dataset of images as:

$$\overline{{C}_{i , j}} = avg ( {C}_{ij}^{dataset} ) \qquad Eq . ( 2 )$$

In one or more embodiments of the present disclosure, the averaged joint-joint correlation C̅i̅,̅j̅ is considered a generalized joint-joint correlation score of human body joints. For example, C̅2̅5̅,̅2̅6̅ has a high value. C̅2̅5̅,̅2̅6̅ is the correlation between the left knee and right knee. The correlation value between a left and a right knee is high as the movement associated with the left and right knee is highly correlated.

Further, the joint-object score determiner 164 determines the joint-object score based on the determined joint interaction score and the determined joint-to-joint correlation. In one or more embodiments of the present disclosure, the joint-object score determiner 164 determines the joint-object score based on the joint-to-joint correlation enforced on the determined joint-interaction relation. In one or more embodiments of the present disclosure, the joint-object score is a representation of the involvement of the plurality of user body joints of the human (J₁, J₂, . . . , J_{N}) with the at least one object. A higher joint-object score for a given body joint implies a higher degree of involvement of the given body joint. The joint-object score of a joint Jᵢ associated with Object Oⱼ is defined as:

$${S}_{Jij} = {J}_{1} - {I}_{j} * \overline{{C}_{1 , i}} + {J}_{2} - {I}_{j} * \overline{{C}_{2 , i}} + … {J}_{N} - {I}_{j} * \overline{{C}_{N , i}} ; \qquad Eq . ( 3 )$$

$${S}_{Jij} = {\sum }_{x = 1}^{N} {J}_{x} - {I}_{j} * \overline{{C}_{x , i}} , 0 \leq i \leq N , 0 \leq j \leq K$$

In one or more embodiments of the present disclosure, Jₓ-Iⱼ is the joint-interaction score of x^{th} joint for interaction with object Oⱼ, C̅x̅,̅i̅ is the averaged joint-joint correlation between body joints Jₓ and J₁. In one or more embodiments of the present disclosure, the joint-object score as determined above shows that a joint-object score of a given body joint is dependent on the joint-interaction relation and joint-joint correlation of all the body joints with the given body joint. Thus, the joint-object score considers the interaction with the object considering the joint-joint correlation. As an example, when the user plays with the hula-hoop using her hips, the knee joint score may also be considered as the knee joint score is correlated with the hips. In another example, when hips and legs have a higher interaction relation, knees and waist are assigned a relatively higher score for object hula hoop, than other joints. Further, the details of generating the joint-object score are explained with reference to at least FIG. 6C and FIG. 6D.

Further, the joint-object distance minimizer 166 may be configured to generate the set of user poses corresponding to the at least one user based on the determined joint-object score. In one or more embodiments of the present disclosure, the set of user poses are generated, such that the joints having a higher joint-object score are positioned closer to the at least one object. Other joint-constrained motions are considered to generate a set of poses. For example, for a number of interactions involving the waist, and hips, constrained combinations of other joints, such as legs, hands, and the like may be generated. For generating the set of user poses, the joint-object distance minimizer 166 determines a plurality of surface points on each of the set of surface areas of the at least one object. In one or more embodiments of the present disclosure, the body joints interact with the surfaces of the objects which are found in the object surface estimation step. To determine the discretized object's surface points, longitudinal and latitudinal lines are drawn on the surface for every length L. Thus, the plurality of surface points is represented as p^{t}k_j is defined as follows:

$${ptk}_{j} = intersection points + edge points on object Oj , \qquad Eq . ( 4 )$$

$$∀ k \leq n , j \leq K$$

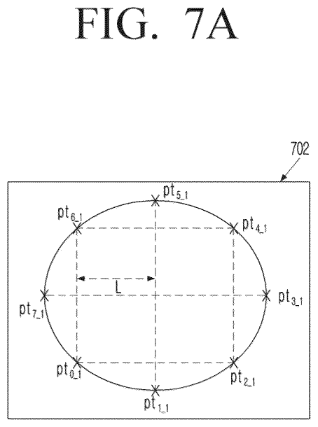

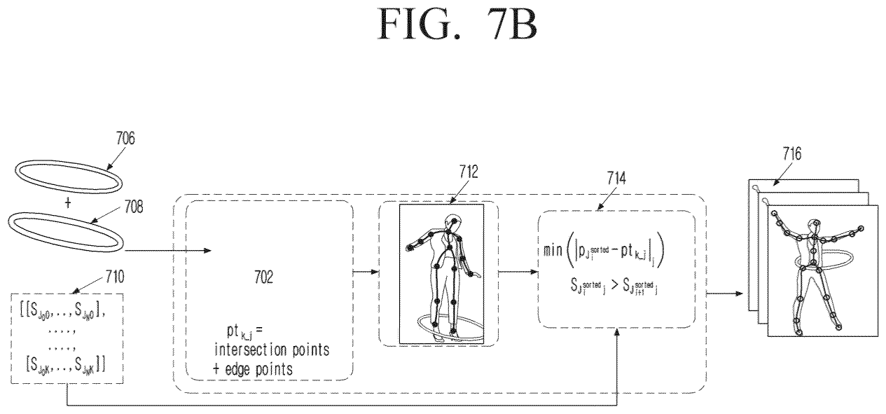

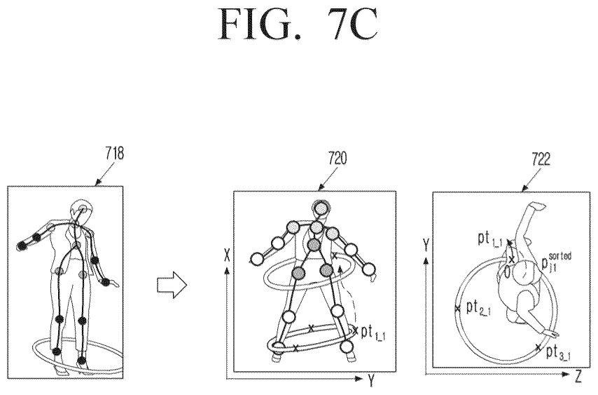

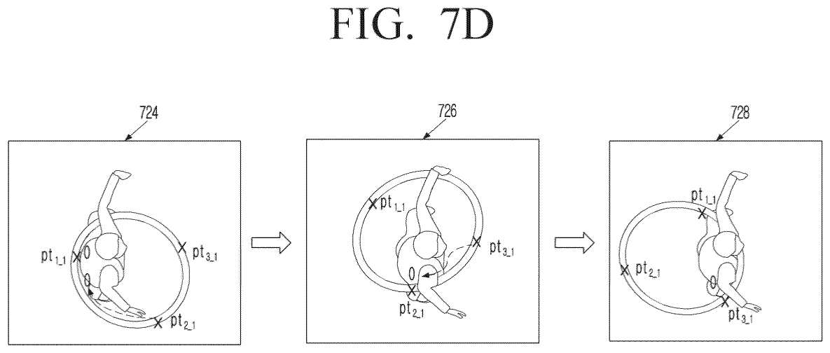

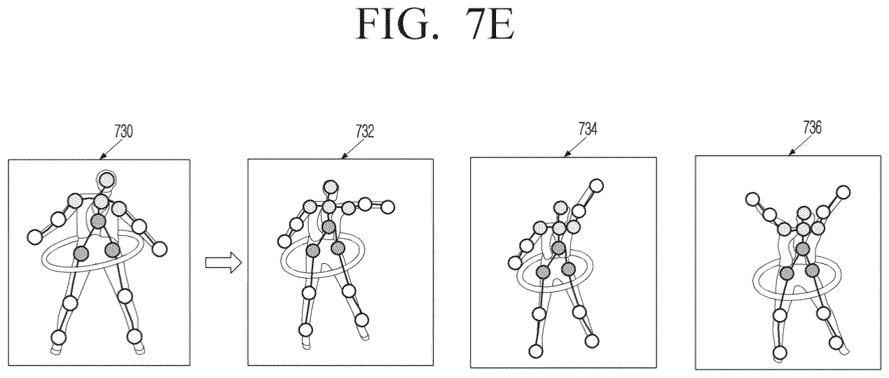

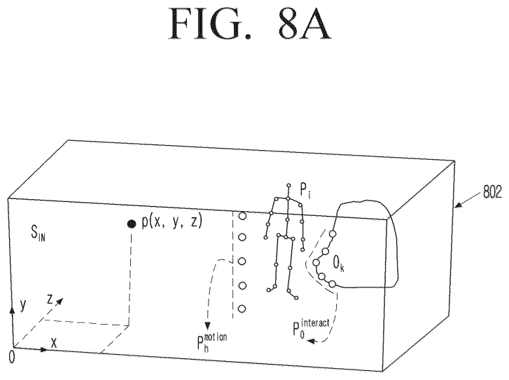

In one or more embodiments of the present disclosure, the intersection points are the points of intersection of the longitudinal and latitudinal lines drawn at distance L. Further, the edge points are points on the edge of the surface after every length L. n is the total number of points possible on the surface of object O₁. Further, the plurality of surface points on the at least one object is depicted in FIG. 7A.

Further, the joint-object distance minimizer 166 may be configured to modify one or more positions of the plurality of user body joints in the input image based on a relation associated with a distance between the plurality of user body joints and the at least one object based on the determined joint-object score, the determined plurality of surface points, and one or more predefined articulation parameters associated with the user pose. In one or more embodiments of the present disclosure, the relation associated with the distance between the plurality of user body joints and the at least one object corresponds to minimizing or maximizing the distance between the plurality of user body joints and the at least one object. For example, modifying the one or more positions of the plurality of user body joints in the input image corresponds to minimizing the distance between the plurality of user body joints and the determined plurality of surface points of the at least one object based on the determined joint-object score. In one or more embodiments of the present disclosure, the plurality of user body joints is sorted according to the joint-object score for each of the at least one object. The sorted plurality of user body joints are represented as:

$${\{ {J}_{1}^{sorted} , … , {J}_{i}^{sorted} , {J}_{i + 1}^{sorted} , … , {J}_{N}^{sorted} \}}_{i} ; \\ such that {S}_{Ji}^{sortedj} > {S}_{Ji + 1}^{sortedj} \qquad Eq . ( 5 )$$

In one or more embodiments of the present disclosure,

$${J}_{i}^{sorted}$$

represent i^{th} body joint sorted according to the joint-object score. Further,

$${S}_{Ji}^{sortedj}$$

represents the joint object score of

$${J}_{i}^{sorted}$$

associated with Oⱼ ∀1≤j≤K. For example, for a given sorted joint-object score for hula-hoop O₁ as follows:

$${S}_{Left Hip j} = {S}_{right Hip j} > {S}_{centroidj} > {S}_{Left shoulder j} > ⋯ > {S}_{right elbow j} > {S}_{Left elbow j} > {S}_{wrist j} > {S}_{Knee j} \qquad Eq . ( 6 )$$

In one or more embodiments of the present disclosure, the sorted body joints in accordance with the equation (6) are

$$\{ {J}_{1}^{sorted} = right elbow , {J}_{2}^{sorted} = left elbow , ⋯ {J}_{N}^{sorted} = Head .$$

Further, the modification of the plurality of user body joints is done for each of the sorted plurality of body joints in order, such that:

$${min ( \vert {P}_{J 1}^{sorted} - {P}_{{tk}_{j}} \vert )}_{j} , {min ( \vert {P}_{J 2}^{sorted} - {P}_{{tk}_{j}} \vert )}_{j} … {min ( \vert {P}_{JN}^{sorted} - {P}_{{tk}_{j}} \vert )}_{j} \qquad Eq . ( 7 )$$

In one or more embodiments of the present disclosure, the plurality of surface points Pₜₖ_{ⱼ}, k≤n for each of the at least one object Oj,j≤k. For example, the modification of the plurality of user body joints is done to minimize the distance between the plurality of surface points and the plurality of user body joints, starting from the

$${J}_{1}^{sorted}$$

i.e., joint having a maximum joint-object score, then

$${J}_{2}^{sorted}$$

and finally

$${J}_{N}^{sorted} ,$$

i.e., joint having a minimum joint-object score.

Further, the joint-object distance minimizer 166 may be configured to generate the set of user poses based on a modification of the one or more positions of the plurality of user body joints in the input image (i.e., minimizing the distance between the plurality of surface points and the plurality of user body joints). In one or more embodiments of the present disclosure, all the combinations of poses generated as per the above minimization are considered by the system 100, such that there are n₁ pose(s) for a displacement of body joint

$${J}_{1}^{sorted} .$$

For each of the n₁ pose(s), displacement of body joints

$${J}_{2}^{sorted}$$

are done to generate a total of n₂ pose(s) and so on. Thus, a total of n₁*n₂* . . . n_{N} number of pose(s) are generated. In one or more embodiments of the present disclosure, the total of n₁*n₂*. . . n_{N} a number of pose(s) generated by minimizing the distance between the plurality of user body-joints and the plurality of surface points based on the joint-object score are referred to as the set of user poses. In one or more embodiments of the present disclosure, the set of user poses C_{Pose} is defined as a collection of a number of pose(s) as defined by the following equation.

$${C}_{Pose} = \{ {P}_{1} , {P}_{2} , … {P}_{M} \} \qquad Eq . ( 8 )$$

In one or more embodiments of the present disclosure, M=n₁*n₂*. . . n_{N}, is the total number of combinations of pose(s). Further, n₁≤n,n₂<n, . . . n_{N}<n, where n is the total number of object's surface points. Each of the number of pose(s) Pᵢ∈{P₁,P₂, . . . P_{M}}i^{th} pose amongst the set of user posesC_{Pose} defined using the below equation:

$${P}_{i} ' \{ {P}_{J 1} , {P}_{J 2} , … {P}_{JN} , … , {P}_{O 1} , {P}_{O 2} , … {P}_{OK} \} \qquad Eq . ( 9 )$$

In one or more embodiments of the present disclosure, P_{J1},P_{J2}, . . . P_{JN} represent the 3D Cartesian coordinates of the plurality of user body joints, corresponding to Pᵢ which are generated in accordance with the Body Joint distance minimization criteria, Further, P_{O1},P_{O2}, . . . P_{OX} represent 3D cartesian coordinates of each of the at least one object, corresponding to Pᵢ i.e., Pⱼₖ={x_{Jk},y_{Jk},z_{jK}} and P_{Oj}={x_{OJ},y_{OJ},z_{Oj}} ∀ k≤N and j≤K. Thus, the set of poses C_{Pose}={P₁,P₂, . . . P_{M}} is output, considering a number of pose(s) generated by displacing the plurality of user body joints in accordance with the minimization of distance. It is important to mention that while displacing the plurality of user body joints of a given user pose, the body-joints are displaced in such a way that the articulation of the body pose is maintained. For example, if a person is facing the XY plane, the elbow movement in a z-axis is mainly due to flexion and extension and the movement in the X-Y plane is due to medial and lateral rotation. Thus, the displacement of all the joints is done maintaining the constraints of articulation of human body-joints. Further, the details on the working of the pose combination generator 148 to generate the set of user poses are explained with reference to at least FIG. 7B, FIG. 7C, FIG. 7D, and FIG. 7E.

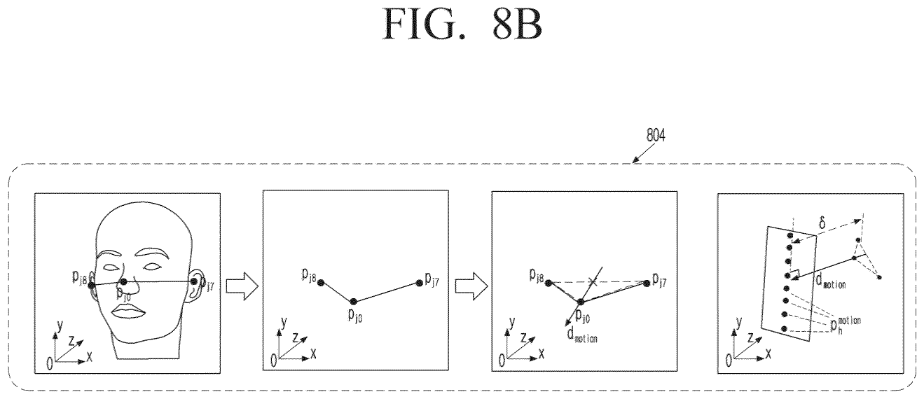

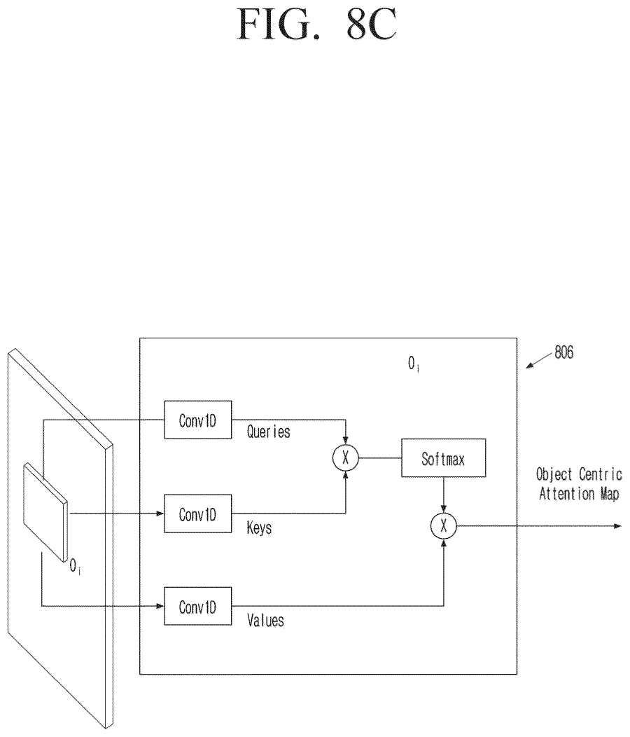

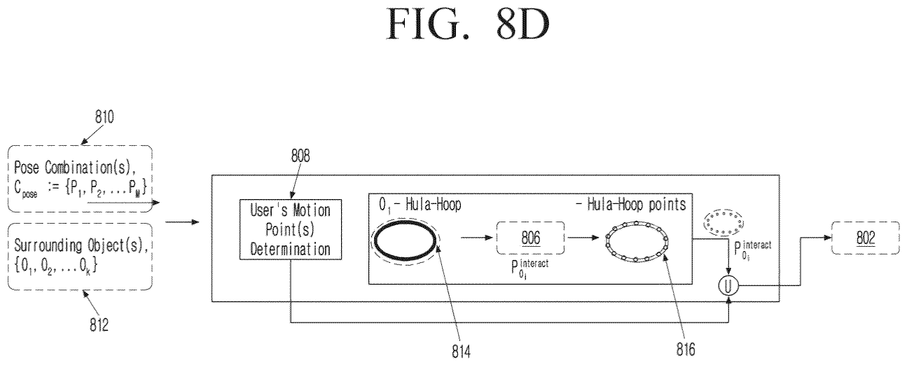

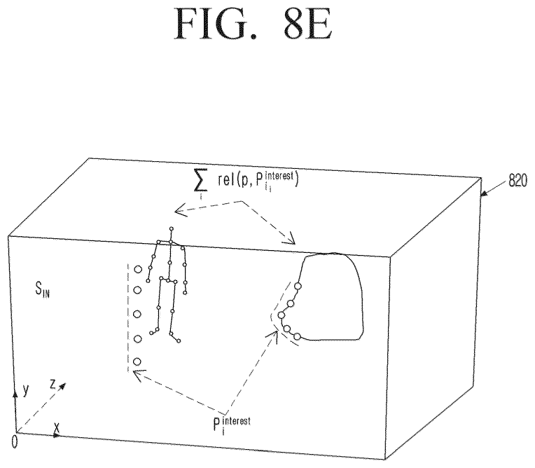

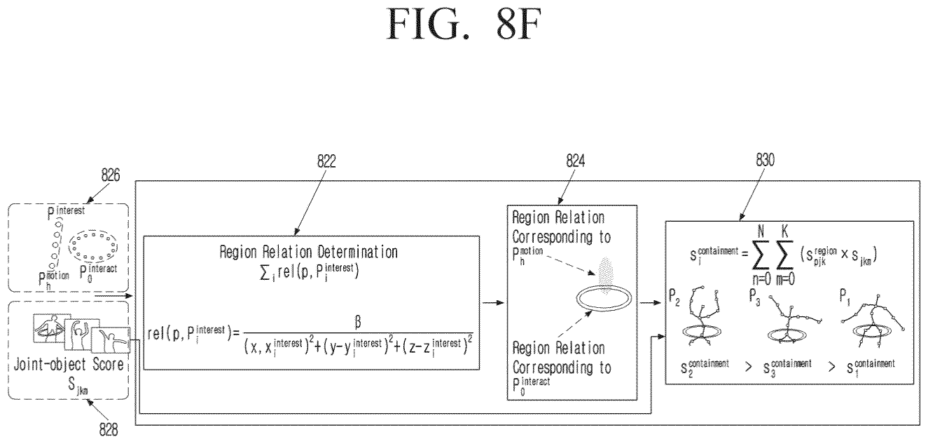

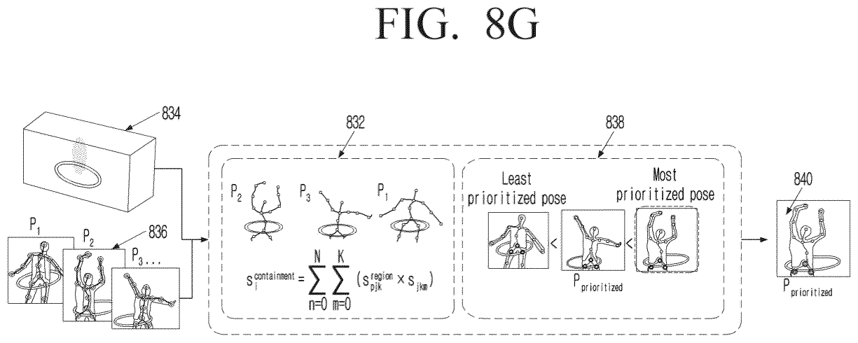

In one or more embodiments of the present disclosure, the pose prioritizer 152 may be configured to determine an optimal user pose amongst the generated set of user poses. The optimal user pose corresponds to the most appealing and natural pose of a human around an object. In determining the optimal user pose, the point(s) of interest determiner 172 may be configured to determine, for each of the generated set of user poses, one or more points of interest in the input image. In one or more embodiments of the present disclosure, the one or more points of interest in the input image corresponding to points in an input space which is of interest to the at least one user, points that are located on or around the at least one object, and points in a direction of motion of the at least one user. In one or more embodiments of the present disclosure, the points that are located on the at least one object have a higher probability of being interacted by the at least one user. Further, the one or more points of interest are shown in FIG. 8A.

In one or more embodiments of the present disclosure, the one or more points of interest (P^{interest}) are a union of the user's motion points

$${P}_{h}^{motion}$$

and object interaction points

$${P}_{O}^{interact} .$$

$${P}^{interest} = {P}_{h}^{m o t i o n} ⋃ {P}_{O}^{interact} \qquad Eq . ( 10 )$$

The object interaction points are points on objects which have a high probability of interaction with a human. As an example, the object interaction points for a cup may lie around its handle, or object interaction points of a table may lie around the edges of the table.

In one or more embodiments of the present disclosure, the point(s) of interest determiner 172 may be configured to determine a direction of motion of the user in focus for each set of user poses. The direction of motion of the user dₘₒₜᵢₒₙ may be determined using a relative position of body-joints poses pⱼᵢ. For example, when the body joints are nose, left ear, and right ear and pⱼ₀, pⱼ₇, pⱼ₈ as the positions of Nose, Left Ear, and Right Ear respectively, the direction of motion dₘₒₜᵢₒₙ, for a pose Pᵢ is determined as follows

$$\vec{{d}_{motion}} = {x}_{motion} \hat{i} + {y}_{motion} \hat{j} + {z}_{motion} \hat{k} , where \hat{i} , \hat{j} and \hat{k}$$

are unit vectors along the x, y, and z axes, respectively.

$${x}_{motion} = {x}_{j 0} - \frac{{x}_{j 7} + {x}_{j 8}}{2} ; \qquad Eq . ( 11 )$$

$${y}_{motion} = {y}_{j 0} - \frac{{y}_{j 7} + {y}_{j 8}}{2} ;$$

$${z}_{motion} = {z}_{j 0} - \frac{{z}_{j 7} + {z}_{j 8}}{2}$$

In one or more embodiments of the present disclosure, the direction of motion is further used to determine the user's motion points

$${P}_{h}^{motion} .$$

User's motion points are the points lying in a plane perpendicular to the direction of motion, at an average distance of 6 from one or more body joints pose. Thus, points

$${P}_{h}^{motion}$$

are taken such that they satisfy the plane equation. xₘₒₜᵢₒₙ x+yₘₒₜᵢₒₙ y+zₘₒₜᵢₒₙ z=d. Further, the user's motion points are shown in FIG. 8B.

Further, the point(s) of interest determiner 172 may use the at least one object {O₁, O₂, . . . O_{K}} to determine one or more interaction points on the at least one object. Firstly, an object-level appearance feature,

$${x}_{inst}^{{O}_{\text{?}}} ,$$

$$\text{?} \text{indicates text missing or illegible when filed}$$

is extracted using the standard process, e.g., applying region of interest pooling, passing through a residual block (res5), followed by the Global Average Pooling (GAP). Next, a dynamically generated attention map is generated, by embedding the appearance feature,

$${x}_{inst}^{{O}_{\text{?}}}$$

$$\text{?} \text{indicates text missing or illegible when filed}$$

and the convolutional feature map onto a 512-dimensional space, and measuring similarity using vector dot product. Further, an object-centric attention map,

$${A}_{\text{?}}^{map} ,$$

$$\text{?} \text{indicates text missing or illegible when filed}$$

is then observed after applying softmax. FIG. 8C shows an architecture of an object-centric attention network. The object-centric attention Map

$${A}_{{o}_{\text{?}}}^{map}$$

$$\text{?} \text{indicates text missing or illegible when filed}$$

highlights relevant regions that have a high probability of interaction. Thus, for a given Pose Pⱼ∈C_{Pose} and a given object Oᵢ, the one or more interaction point(s),

$${P}_{{O}_{\text{?}}}^{interact} ,$$

$$\text{?} \text{indicates text missing or illegible when filed}$$

is determined as:

$${P}_{{O}_{\text{?}}}^{i n t e r a c t} = \{ {x}_{{I}_{{o}_{\text{?}}}} , {y}_{{I}_{{o}_{\text{?}}}} , {z}_{{I}_{{o}_{\text{?}}}} \} \qquad Eq . ( 12 )$$

$$\text{?} \text{indicates text missing or illegible when filed}$$

In one or more embodiments of the present disclosure, {x_{Io},y_{Io}} is the point(s) on

$${A}_{{o}_{\text{?}}}^{map}$$

$$\text{?} \text{indicates text missing or illegible when filed}$$

having the highest score and {z_{Io}}=z_{O}_{ᵢ}, where z_{O}_{ᵢ} is the z coordinate of the object pose p_{O}_{ᵢ}∈Pⱼ. Details on the working of the point(s) of interest determiner 172 for determining the one or more points of interest are explained with reference to at least FIG. 8C.

Further, the containment score determiner 174 may be configured to determine a containment score associated with each of the generated set of user poses based on the determined joint-object score and the one or more points of interest in the input image. In one or more embodiments of the present disclosure, the containment score is a measure of a body joint of the human pose Pᵢ falling close to the points of interest in the input space. The containment score is generated for each pose Pᵢ∈Cₚₒₛₑ. For determining the containment score, the containment score determiner 174 may be configured to identify one or more regions around the determined one or more points of interest. Further, the containment score determiner 174 may be configured to generate a region score for each of the identified one or more regions based on a distance between the identified one or more regions and the one or more points of interest. In one or more embodiments of the present disclosure, a region in the input space, S_{IN}, is assigned a relation with respect to each of the one or more points of interest, P^{interest}. The one or more points of interest are the points having a high probability of interaction with the object or in the direction of motion of the user. Every point in the input space is assigned a value with respect to its relation to the one or more points of interest. Mathematically, given a point, p(x,y,z) and a total of I points of interest

$${P}^{interest} = \{ {P}_{1}^{interest} , {P}_{2}^{interest} , … {P}_{I}^{interest} \} ,$$

a relation is determined as follows:

$$Region Relation of point p = {\sum }_{i} rel ( p , {P}_{i}^{interest} ) \qquad Eq . ( 13 )$$

In one or more embodiments of the present disclosure,

$$rel ( p , {P}_{i}^{interest} )$$

is the relation between any given point in the space and i^{th} point of interest. The relation

$$rel ( p , {P}_{i}^{interest} )$$

is a function of position (x,y,z) of any point p and position

$$( {x}_{i}^{interest} , {y}_{i}^{interest} , {z}_{i}^{interest} )$$

of i^{th} point of interest. The relation

$$rel ( p , {P}_{i}^{interest} )$$

is defined as below:

$$rel ( p , {P}_{i}^{interest} ) = \frac{β}{{( x - {x}_{i}^{interest} )}^{2} + {( y - {y}_{i}^{interest} )}^{2} + {( z - {z}_{i}^{interest} )}^{2}} \qquad Eq . ( 14 )$$

In one or more embodiments of the present disclosure, β≥1 is a constant. The region relation,

$${s}_{p}^{region} ,$$

is thus, a measure of interest level of any point in space for the user. A higher value implies a higher interest. Further, the region scores around the one or more points of interest are shown in FIG. 8E.

Furthermore, the containment score determiner 174 may be configured to determine the containment score for each of the generated set of user poses based on the determined joint-object score and the generated region score upon determining the region relation. The containment score is calculated using equation (15):

$${s}_{i}^{contaniment} = {\sum }_{n = 0}^{N} {\sum }_{m = 0}^{K} ( {s}_{{p}_{j k}}^{region} \times {S}_{{J}_{k} m} ) \qquad Eq . ( 15 )$$

where,

$${s}_{i}^{containment}$$

is the containment score for i^{th} Pose, Pᵢ∈Cₚₒₛₑ,

$${s}_{{p}_{jk}}^{region}$$

is the region relation assigned to the point p_{Jk}={x_{Jk}, y_{Jk}, z_{Jk}}, i.e., position of k^{th} Joint of Pose Pᵢ. Further, S_{J}_{ₖ}ₘ is the Joint object score of k^{th} Joint of Pose Pᵢ with m^{th} object. In one or more embodiments of the present disclosure, the containment score is a measure of the containment level of a joint in the region of input space. The product of a region score and the joint-object score is a measure of how close a joint that is directly related to the object lies in the region around the point(s) of interest to the user. In one or more embodiments of the present disclosure, the region around the one or more point of interest is assigned a relation inversely related to the distance from the one or more point of interest. Further, the details on generating the containment score are explained with reference to at least FIG. 8F.

Further, the containment score-based prioritizer 176 may be configured to determine the optimal user pose amongst the generated set of user poses based on the determined containment score. In one or more embodiments of the present disclosure, prioritization of the set of poses is done according to the containment score. A pose having a higher containment score is having a higher priority. For example, a pose with hands away from the hula-hoop is having the highest priority. Thus, prioritized pose(s), P_{prioritized} is defined by using equation (16). Details on prioritizing the set of poses are explained with reference to at least FIG. 8G.

$${P}_{prioritized} = set of poses prioritized according to the containment score {s}_{i}^{containment} = \{ {P}_{1} , {P}_{2} , … {P}_{i} , {P}_{i + 1} , … {P}_{N} \} such that {s}_{i}^{containment} > {s}_{i + 1}^{containment} \qquad Eq . ( 16 )$$

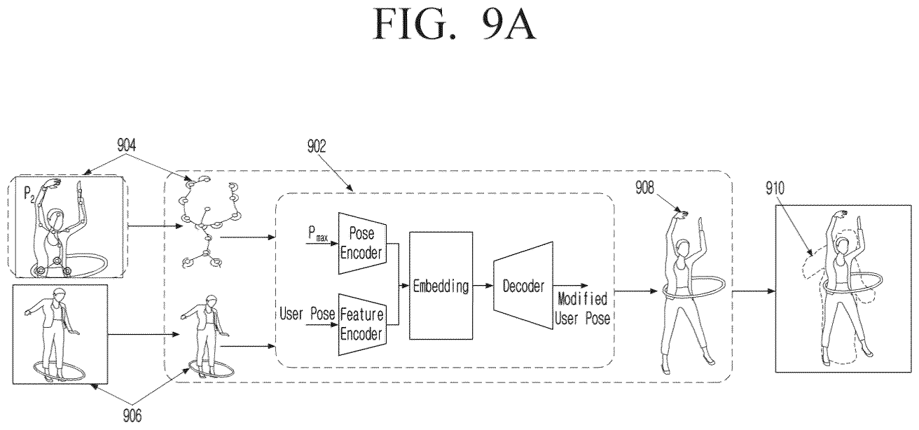

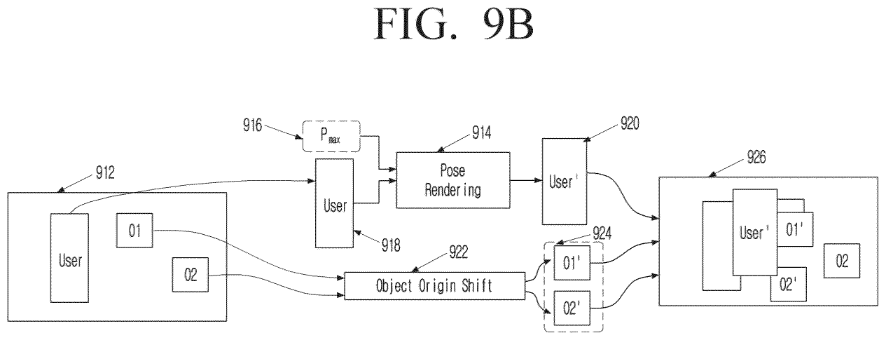

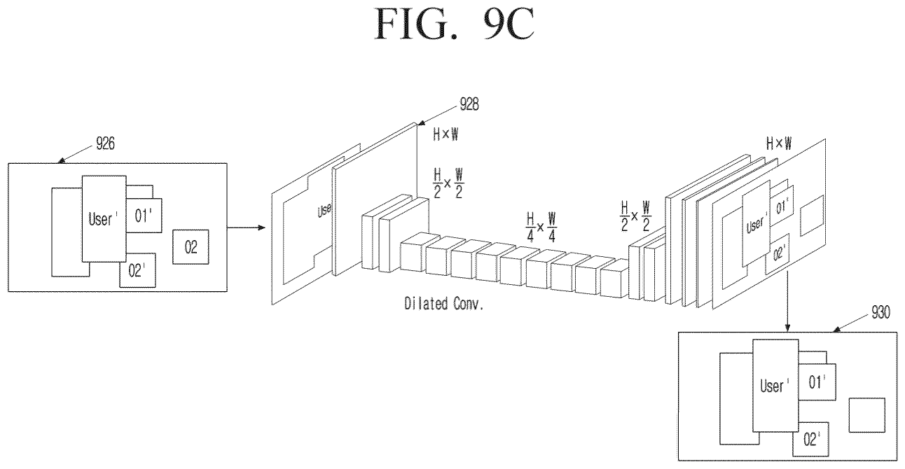

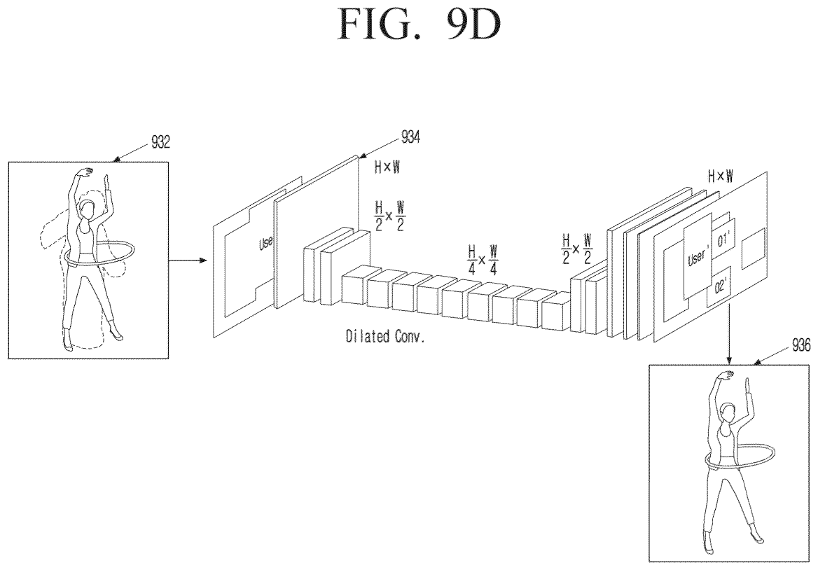

Further, the image reconstructor 150 may be configured to modify the user pose associated with the at least one user and an object orientation associated with the at least one object in the input image in context with the determined optimal user pose. In an exemplary embodiment of the present disclosure, the object orientation may be changed from an upright position to a downward position. For modifying the user pose, the pose renderer 168 may be configured to identify one or more exposed spaces and one or more hidden spaces in the input image upon modifying the user pose and the object orientation in the input image. The pose renderer 168 utilizes the pose having a highest priority, Pₘₐₓ amongst the prioritized pose(s), P_{prioritized} and accordingly modifies the pose of the user in focus and also the pose/orientation of the objects. In one or more embodiments of the present disclosure, the pose renderer 168 combines the input image along with the target pose as inputs and generates a realistic image by GANs. For example, the original object's pose in the input image may also be changed based on the pose of the object in the Pₘₐₓ being used. This is only displacing the centroid of the segmented object to a new location. Details on the operation of the pose renderer 168 are explained with reference to at least FIG. 9A and FIG. 9B.

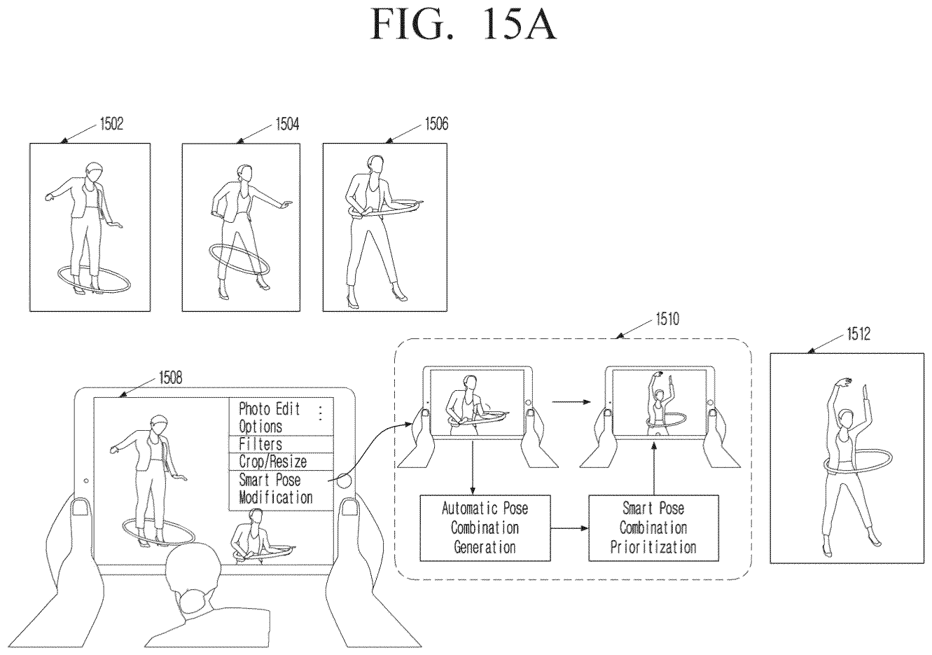

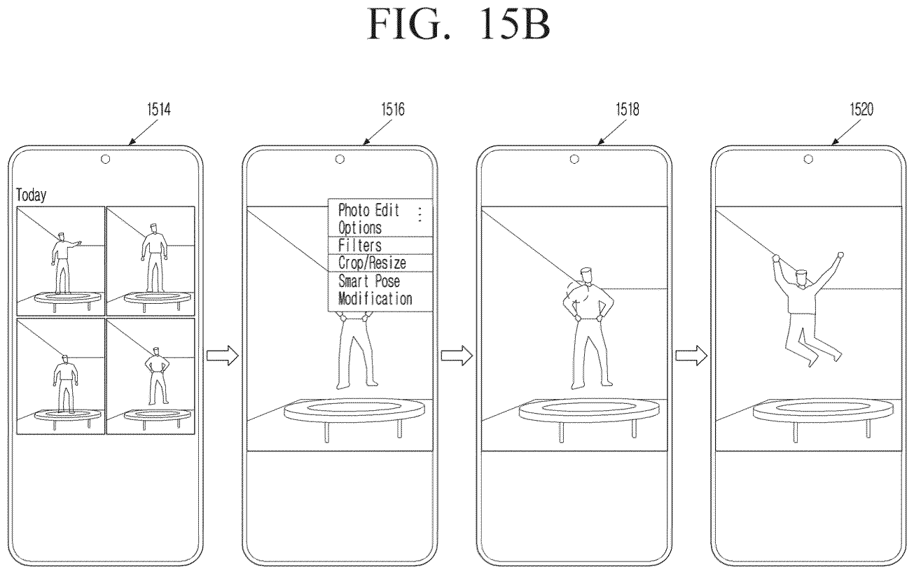

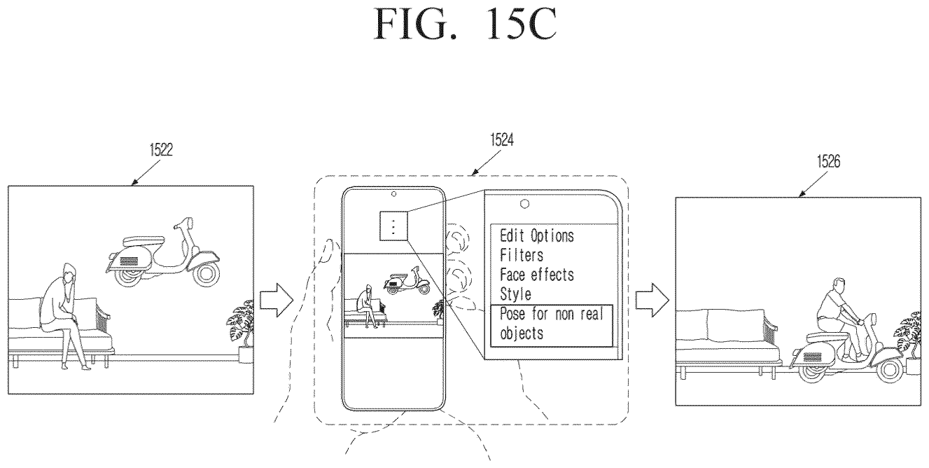

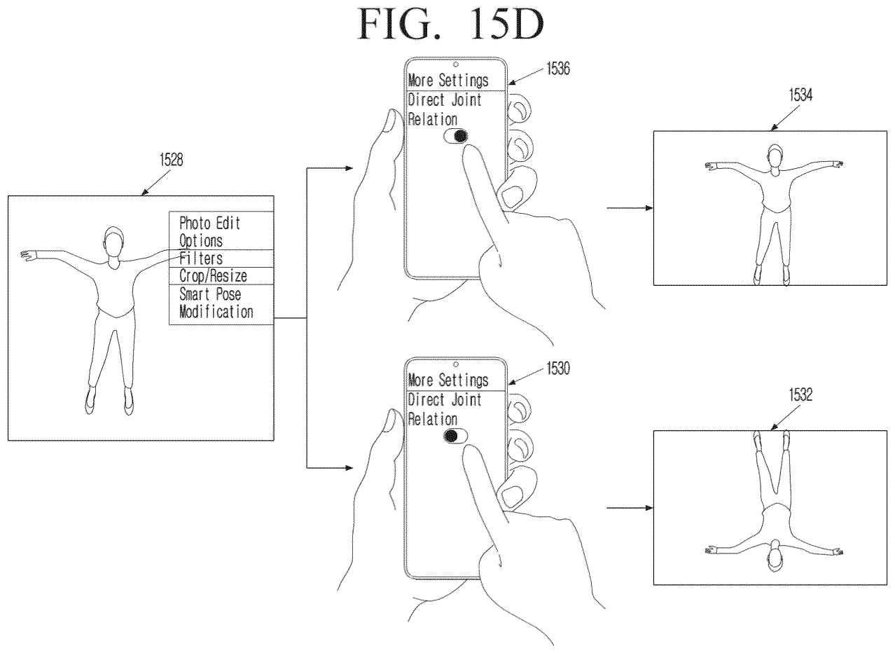

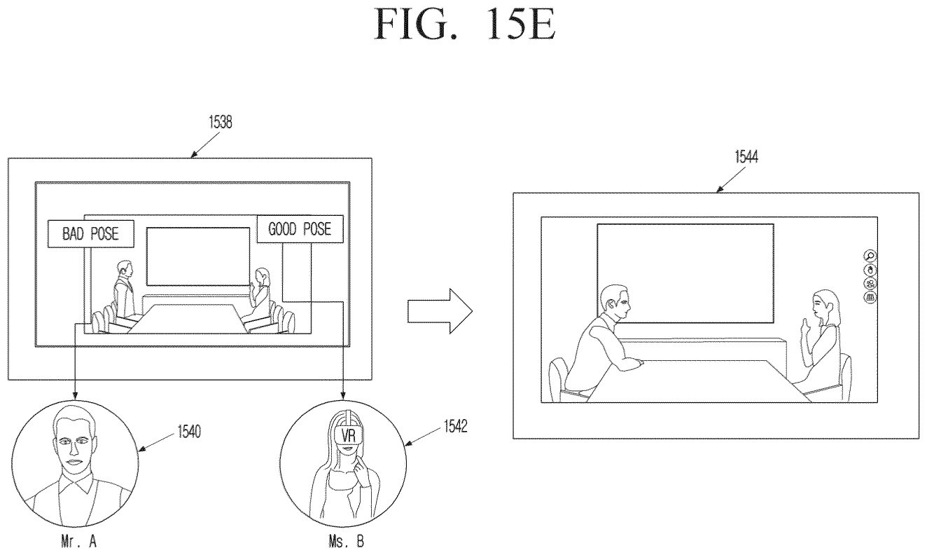

In one or more embodiments of the present disclosure, the pose rendering step to modify the at least one user's pose and the at least one object's position/orientation exposes parts of an image (the one or more exposed spaces and the one or more hidden spaces) that need to be completed. Thus, image in-painting or image completion is required to complete the reconstructed image. In one or more embodiments of the present disclosure, the image in-painter 170 may be configured to perform an image inpainting operation on the input image for reconstructing the identified one or more exposed spaces and the identified one or more hidden spaces. Details on the operation of the image in-painter 170 are explained with reference to at least FIG. 9C and FIG. 9D. Further, details on the operation of the system 100 are explained with reference to at least FIG. 14. Furthermore, the use-case scenarios of the system 100 are explained with reference to at least FIG. 15.

FIG. 2 illustrates a schematic representation depicting the working of the surrounding object determiner to extract the set of features from the input image, according to one or more embodiments of the present disclosure. The surrounding object determiner is configured to extract the plurality of features from the input image, as explained in detail with reference to FIG. 1.

As depicted, step 202 represents receiving the input image of a user with the hula-hoop. At step 204, the image segmentation is performed on the input image by using the mask RCNN. At step 206, the user and the object i.e., the hula-hoop is identified based on a result of performing the image segmentation process. Further, at step 208, a segment localization process is performed on the input image, and for each object (Oᵢ) a class of the object (Cᵢ), a centroid of the object (CPₒᵢ), and a mask of the object are determined. At step 210, the at least one object: the hula-hoop (O₁-surrounding object), Human (O_{H1}-human object) and hula-hoop centroid CPₒ₁ (xₒ₁, yₒ₁), human centroid Cp_{oH1} (x_{oH1}, y_{oH1}). Thus, each of the at least one object [O₁, O₂, . . . Oₖ] is represented as the class of the object (Cᵢ), the centroid of the object (CPₒᵢ), and the mask of the object, where the class of objects and the centroid of the object are determined in the image segmentation process.

FIG. 3A is a schematic representation for detecting the pose of the at least one user, according to one or more embodiments of the present disclosure. The concept of detecting the pose of the at least one user is explained in FIG. 1.

As depicted, step 302 represents the segmented input image with the user and the object (hula-hoop). Further, at step 304, the pose of the at least one user is determined. Specifically, in step 306, the 2D pose of the user is determined by using a DNN regressor. Further, at step 308, the 3D pose of the user is estimated. Step 310 represents an output of the 2D pose of the user.

FIG. 3B is a pictorial representation of an exemplary key joint topology of a human pose, according to one or more embodiments of the present disclosure. The concept of key joint topology is briefly explained in FIG. 1.

As depicted, element 312 represents the key joint topology of a human pose with a total of 33 movable body joints. In an exemplary embodiment of the present disclosure, the 33 movable body joints are 1 nose, 2 left eye inner, 3 left eye, 4 left eye outer, 5 right eye inner, 6 right eye, 7 right eye outer, 8 left ear, 9 right ear, 10 mouth left, 11 mouth right, 12 left shoulder, 13 right shoulder, 14 left elbow, 15 right elbow, 16 left wrist, 17 right wrist, 18 left pinky #1 knuckle, 19 right pinky #1 knuckle, 20 left index #1 knuckle, 21 right index #1 knuckle, 22 left thumb #2 knuckle, 23 right thumb #2 knuckle, 24 left hip, 25 right hip, 26 left knee, 27 right knee, 28 left ankle, 29 right ankle, 30 left heel, 31 right heel, 32 left foot index, and 33 right foot index for example.

FIG. 3C is a schematic representation for converting the 2D body joint coordinates of the user into the 3D Cartesian coordinates, according to one or more embodiments of the present disclosure. The concept of converting the 2D body joint coordinates of the user into the 3D Cartesian coordinates is explained in FIG. 1.

As depicted, element 314 represents the 2D pose of the user in the XY plane. For every 2D body joint coordinates jᵢ (xᵢ, yᵢ), a Jᵢ(xᵢ, yᵢ, zᵢ) is determined, where Jᵢ represents the 3D Cartesian coordinate of i^{th} body joint of the human pose. Thus, the system 100 uplifts the 2D co-ordinates to the 3D co-ordinates. Further, as depicted, element 316 represents the 3D pose of the user.

FIG. 3D is a schematic representation depicting the 3D space 318 in which the 3D pose of the user is detected, according to one or more embodiments of the present disclosure. The 3D space 318 represents the XYZ plane. The system 100 determines and represents the 3D coordinates of body joints with respect to an origin of the 3D space 318.

FIG. 3E illustrates a schematic representation for determining the 3D pose of the user, according to one or more embodiments of the present disclosure.

As depicted, the system 100 determines the 2D pose of the user at step 320. Element 322 represents the determined 2D pose. At step 324, the 3D pose of the user is determined. Element 326 represents the 2D pose in XY plane, and element 328 represents the 3D pose of the user. Further, element 330 represents the 3D pose of the user in the 3D space 318.

FIG. 4A illustrates a schematic representation for converting the 2D object into the 3D object, according to one or more embodiments of the present disclosure. The object 3D modeler is configured to convert the 2D object into the 3D object, as explained with reference to FIG. 1.

As depicted, architecture 402 represents an architecture of the object construction using the 3D GAN.

FIG. 4B illustrates a schematic representation depicting the working of an object 3D modeler for generating a 3D model and a set of surface areas associated with at least one object, according to one or more embodiments of the present disclosure. In one or more embodiments of the present disclosure, FIG. 4B depicts 2D object into a 3D object representation and surface area of the at least one object.

As depicted, element 404 represents the segmented input image with the user and the object (hula-hoop). At step 406, the object 3D modeling is performed. Specifically, at step 408, a portion of the input image depicting the object is obtained. Further, the object construction operation is performed on the obtained portion by using the 3D GAN model at step 410. At step 412, the 3D model of the object is obtained. 414 represents the 3D model of the object. Further, at step 416, the object surface estimation operation is performed for estimating the set of surface areas 418 of the object.

FIG. 5 illustrates a schematic representation depicting the working of the context determiner 160 for determining the one or more possible user interactions, according to one or more embodiments of the present disclosure. The working of the context determiner 160 is explained in detail with reference to FIG. 1.

As depicted, element 502 represents an object (O1). At step 504, an interaction determination operation is performed. Specifically, in the interaction determination operation, a context determination operation is performed to determine the one or more contexts of the object at step 506. In the current example, the object is a hula-hoop, and the context is a toy. Further, at step 508, an object interaction determination operation is performed to determine the one or more possible user interactions 510. As depicted, the one or more possible user interactions associated with the object hula-hoop are dance, play, and hold.

FIG. 6A illustrates a block diagram depicting an architecture 602 of a DNN model for generating a joint-interaction relation, according to one or more embodiments of the present disclosure. As depicted, a set of layers of the DNN model processes the one or more possible user interactions to generate the joint-interaction relation. In an exemplary embodiment of the present disclosure, the set of layers includes an input layer, three hidden layers, an output layer, and a tanh activation layer.

FIG. 6B illustrates a pictorial depiction of a joint-to-joint correlation 604, according to one or more embodiments of the present disclosure. As depicted, the joint-joint correlation is determined for a plurality of user body joints, such as the left hip, right hip, right knee, and the like.

FIG. 6C illustrates a pictorial depiction representing a process of generating the joint-object score, according to one or more embodiments of the present disclosure.

As depicted, the joint-to-joint correlation 606 and the joint-interaction score 608 are used to generate the joint-object score 610.

FIG. 6D illustrates a schematic representation depicting the process of generating the joint-object score, according to one or more embodiments of the present disclosure.

As depicted, the one or more possible user interactions 612 is used for determining the joint-interaction relation by using the architecture 602 of the DNN model. Further, the joint-joint correlation 604 is determined. Furthermore, the joint-interaction relation and the joint-joint correlation 604 are used for generating the joint-object score at step 618. The step 618 includes the step 606, the step 608, and the step 610. Further, element 620 represents the current user pose.

FIG. 7A illustrates a pictorial depiction showing the plurality of surface points on the at least one object, according to one or more embodiments of the present disclosure. At step 702, the plurality of surface points on the at least one object are determined by using the 3D model and the set of surface areas associated with the at least one object

In one or more embodiments of the present disclosure, the at least one object is the hula-hoop. The plurality of surface points as determined for the object=hula-hoop, is shown in the figure. The at least one object's surface points (such as pt_{0_1}, pt_{1_1}, . . . N), are the intersection points on the at least one object O₁ which is the hula-hoop.

FIG. 7B illustrates a schematic representation depicting the process of working the pose combination generator 148 to generate the set of user poses, according to one or more embodiments of the present disclosure. The working of the pose combination generator 148 to generate the set of user poses is explained with reference to FIG. 1.

At step 702, the 3D model 706 and the set of surface areas 708 associated with the at least one object are used to determine the plurality of surface points on each of the set of surface areas. Further, the plurality of surface points and the joint-object score 710 are used to minimize the distance between the plurality of surface points and the plurality of user body joints 712, at step 714. Further, the set of user poses 716 is generated based on the result of step 714.

FIGS. 7C-E illustrate a pictorial depiction for generating the set of user poses, according to one or more embodiments of the present disclosure.

As depicted in FIG. 7C, the user's pose is depicted with a hula-hoop. For hula-hoop, the joint-object score may be: S_{Left Hipj}=S_{right HipJ}>S_{centroidj}>S_{leftshoulderj}> . . . >S_{right elbow j}>S_{left elbow j}>S_{wristj}>S_{Knee j}. In one or more embodiments of the present disclosure, starting from the right and left Hip, the objects are displaced so as to minimize the distance between object's surface points and the right and left hip as shown in the FIG. 7C. Feature 718 represents the original pose in which the object is placed towards the joint having a maximum joint-object score. Further, feature 720 and feature 722 represent a first pose generated by the pose combination generator 148 in the XY plane and XZ plane respectively. The

$${PJ}_{1}^{sorted}$$

joint is left hip and right hip as shown in the first pose. In one or more embodiments of the present disclosure, showing displacement of the object's surface points pt_{1_1} to bring them closer to the body joints

$${PJ}_{1}^{sorted} .$$

Similarly, there can be a number of pose(s) so as to minimize the distance of a number of Object surface points from a ptₓ, x≤n and a given body-joint

$${PJ}_{1}^{sorted} .$$

In one or more embodiments of the present disclosure, the ser of user poses are also generated by displacing the body joints of the user to minimize their distance from the object's surface points, in such a way that the articulation of the joints is maintained. Thus, a set of user poses are generated by first displacing the at least one object or the plurality of user body joints having the maximum joint-object score. For example, left hip and right hip, are taken as references to displace first as shown above to generate a number of n1×n2 pose(s). In one or more embodiments of the present disclosure, the set of poses are generated related to the plurality of user body joints with maximum joint-object score which is the left and right hip. The next body joint is considered for displacement, i.e., the centroid. After generating the set of poses based on the body joints which have the higher joint score, a different combination of poses is generated by displacing the other joints which do not have a good joint-object score.

FIG. 7D shows three different poses, pose 724, pose 726, and pose 728, generated by displacing the at least one object towards the hips of the user.

Further, FIG. 7E shows the displacement of other joints after displacing the objects and the joints with higher joint-object scores. FIG. 7E shows four different poses, pose 730, pose 732, pose 734, and pose 736, generated by the movement of wrists and elbows from Pose1. In one or more embodiments of the present disclosure, there may be a set of nearby objects' surface points as shown. Thus, for each of the n₁×n₂ pose(s) generated by displacement of hula-loop, n₃×n₄ pose(s) are generated by considering the displacement of right and left wrists and elbows, to finally generate a total of n₁×n₂×n₃×n₄ pose(s) considering the displacement of the object hula-loop and right, left wrist and elbows altogether. Similarly, the set of user poses is generated in order of the joint-object score, according to the body-joint distance minimization criteria. In one or more embodiments of the present disclosure, the set of user poses is processed to find the most prioritized pose out of the set of user poses.

FIG. 8A illustrates a pictorial depiction 802 showing one or more points of interest in an image space, according to one or more embodiments of the present disclosure.

For each pose, Pᵢ∈Cₚₒₛₑ and the input VR space or the image space as S_{IN}, point(s) of interest, P^{interest} are points of S_{IN} which are of the interest to the user. Further, S_{IN} is a 3D virtual input space, where each point, p has a 3D cartesian coordinate. Further,

$${P}_{i}^{interest}$$

is the i^{th} point of interest such that

$${P}_{i}^{interest} ∈ {S}_{1 n} .$$

FIG. 8B illustrates a schematic representation 804 depicting the determination of the user's motion points, according to one or more embodiments of the present disclosure.

FIG. 8C illustrates a schematic representation depicting the object-centric attention network 806, according to one or more embodiments of the present disclosure. In one or more embodiments of the present disclosure, the object-centric attention network 806 includes a set of layers, such as the region of interest pooling, the res5, the GAP, and the like.

FIG. 8D illustrates a schematic representation depicting the working of the point(s) of interest determiner 172 for determining the one or more points of interest, according to one or more embodiments of the present disclosure.

At step 808, the set of user poses 810 and the at least one object 812 are used to determine the user's motion point(s). Further, at step 814, the set of user poses 810 and the at least one object 812 are used to determine the object interaction point(s) 816. Further, the one or more points of interest 802 are determined based on the determined user's motion point(s) and the determined object interaction point(s).

FIG. 8E illustrates a pictorial depiction 820 showing region scores around the one or more points of interest, according to one or more embodiments of the present disclosure.

FIG. 8F illustrates a schematic representation depicting the working of a containment score determiner, according to one or more embodiments of the present disclosure.

At step 822, the containment score determiner determines the region relation 824 based on the one or more points of interest 826 and the joint-object score 828. Further, at step 830, the containment score is determined based on the joint-object score 828 and the region relation 824.

FIG. 8G illustrates a schematic representation depicting the prioritization of the set of poses, according to one or more embodiments of the present disclosure.

At step 832, the containment score is calculated based on the region relation 834 and the set of user poses 836. Further, at step 838, the optimal pose 840 is determined amongst the set of user poses based on prioritizing teach of the set of user poses by using the calculated containment score.

FIG. 9A and FIG. 9B are schematic representations depicting the working of a pose renderer 168, according to one or more embodiments of the present disclosure.

FIG. 9A depicts image remodeling operation. At step 902, the pose renderer 168 performs a pose transfer method to modify the user pose based on the most optimized pose 904 and the input image 906. Further, feature 908 represents the updated pose. The feature 908 as representing the updated pose comprises of one or more one or more exposed spaces and one or more hidden spaces 910 in the background which are removed by the image in-painting operation, as explained in FIG. 9C and FIG. 9D.

FIG. 9B depicts pose rendering by modifying the pose of the at least one user and the position of the at least one object. As depicted, block 912 represents the position of the user and two objects (O1 and O2). Further, at step 914, pose rendering is performed based on the optimized user pose 916 and the input image 918 of the user for obtaining the modified pose 920 of the user. Further, at step 922, an object origin shift operation is performed on the two objects to obtain the modified positions of the two objects 924. Further, block 926 represents the modified pose of the user and the modified position of the two objects as a result of performing the pose rendering operation and the object origin shift operation.

FIG. 9C and FIG. 9D illustrate schematic representations depicting the working of an image in-painter 170, according to one or more embodiments of the present disclosure.

FIG. 9C depicts an architecture diagram of the image competition operation. As depicted, block 926 represents the modified pose of the user and the modified position of the two objects as a result of performing the pose rendering operation and the object origin shift operation. Further, block 928 represents the image in-painter 170 i.e., a dilated convolutional neural network that performs the image in-painting operation on the features of block 926 for reconstructing the identified one or more exposed spaces and the identified one or more hidden spaces. Further, a reconstructed image 930 is obtained upon performing the inpainting operation.

FIG. 9D depicts the process of removing an exposed unknown area from the modified user pose. Feature 932 represents the exposed unknown area around the user pose. At step 934, the image in-painting operation is performed on the image to reconstruct the exposed unknown area. Further, the reconstructed image 936 is obtained based on the result of the image in-painting operation.

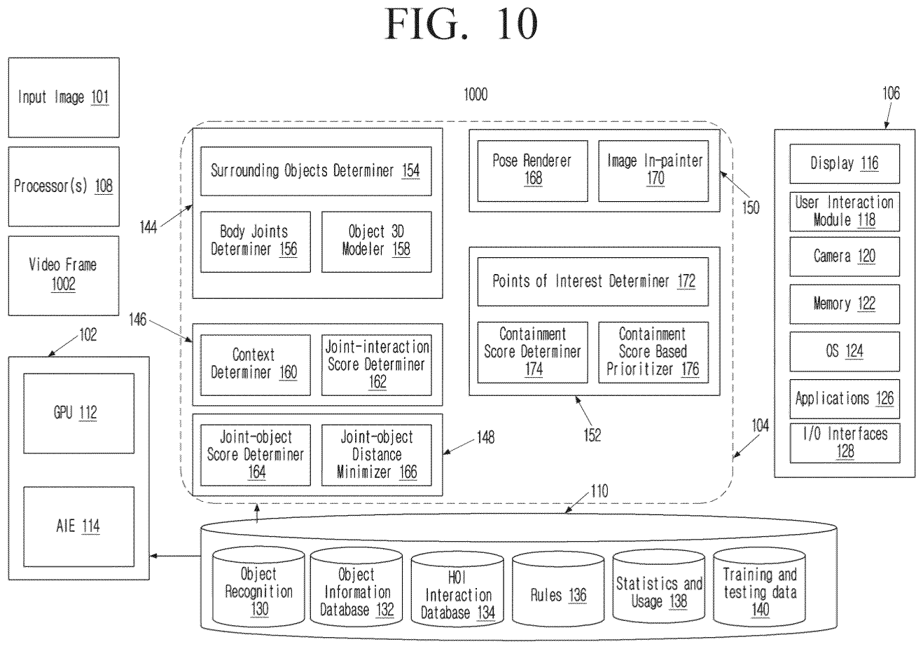

FIG. 10 illustrates a block diagram of an exemplary system 1000 for modifying the user pose in the input image 101, according to another one or more embodiments of the present disclosure. The system 1000 shown in FIG. 10 is similar to the system 100 explained in detail with references to FIG. 1. However, the system 1000 may also be applied to a frame 1002 of a video as the input image 101. Thus, the system 1000 may be used to change the pose of the user in the frame 1002 of the video if the pose of the user is not natural in the frame.

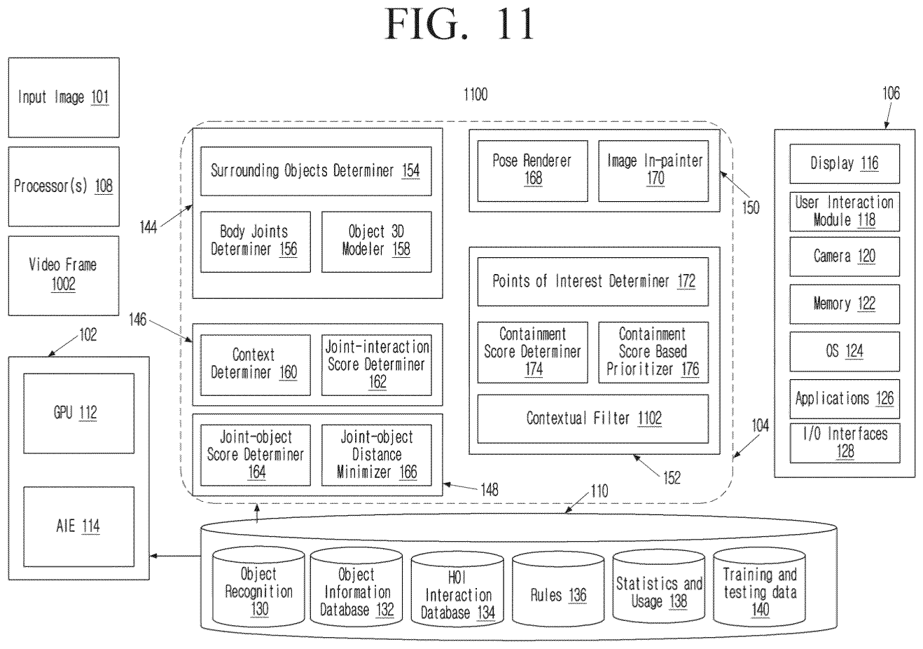

FIG. 11 illustrates a block diagram of an exemplary system 1100 for modifying the user pose in the input image 101, according to yet another one or more embodiments of the present disclosure. The system 1100 shown in FIG. 11 is similar to the system 100 explained in detail with references to FIG. 1 and FIG. 10. However, the pose prioritizer 152 of the system 1100 may include a contextual filter 1102.

In one or more embodiments of the present disclosure, the contextual filter 1102 may be configured to identify a context type of the input image 101 based on the at least one object and surrounding scenes in the input image 101. Further, the contextual filter 1102 may be configured to determine the optimal user pose amongst the generated set of user poses based on the determined containment score and the identified context type. For example, the type of the input image 101 may be a formal or informal based on the surrounding scenes, and the set of user poses may be filtered out to remove a number of informal poses for a formal input surrounding.

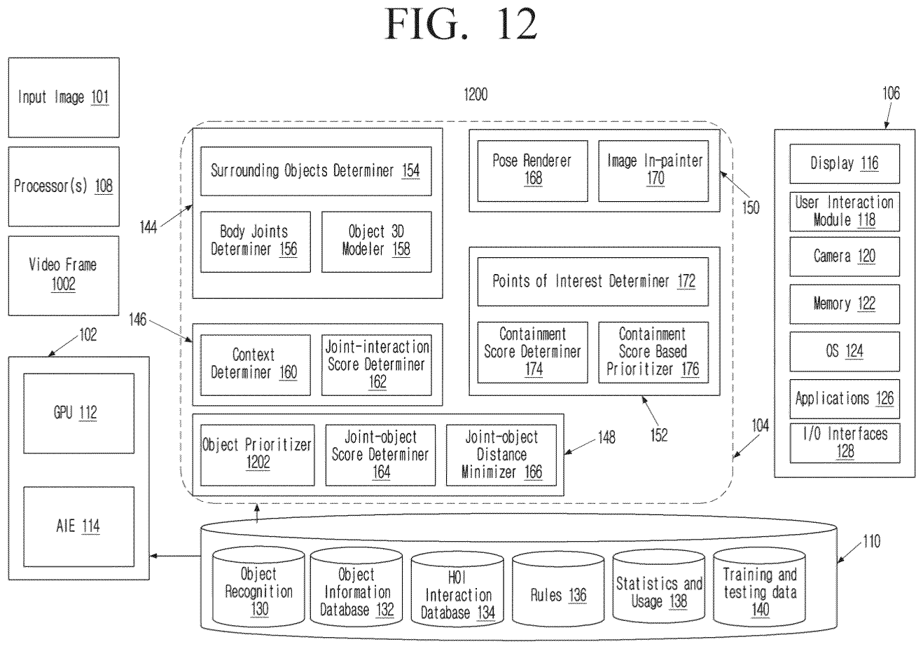

FIG. 12 illustrates a block diagram of an exemplary system 1200 for modifying the user pose in the input image 101, according to another one or more embodiments of the present disclosure. The system 1200 shown in FIG. 12 is similar to the system 100 explained in detail with references to FIG. 1 and FIG. 10. However, the pose combination generator 148 of the system 1200 may include an object prioritizer 1202.

In one or more embodiments of the present disclosure, the object prioritizer 1202 may be configured to determine a priority of the at least one object based on one or more object parameters. In an exemplary embodiment of the present disclosure, the one or more object parameter corresponds to parameters associated with a distance relationship between the at least one user and the at least one object in the input image 101, parameters associated with an object type of the at least one object, parameters associated with the object orientation, and parameters associated with the user pose. Further, the object prioritizer 1202 may be configured to generate the set of user poses corresponding to the at least one user based on the determined joint-object score and the determined priority. In one or more embodiments of the present disclosure, the object prioritizer 1202 determines the pose which is more appropriate for the prioritized object or avoids the poses which are related to the low prioritized object.

Further, the object prioritizer 1202 may be configured to receive at least one user input to prioritize the at least one object for generating the set of user poses. Furthermore, the object prioritizer 1202 may be configured to generate the set of user poses corresponding to the at least one user based on the received at least one user input and the determined joint-object score.

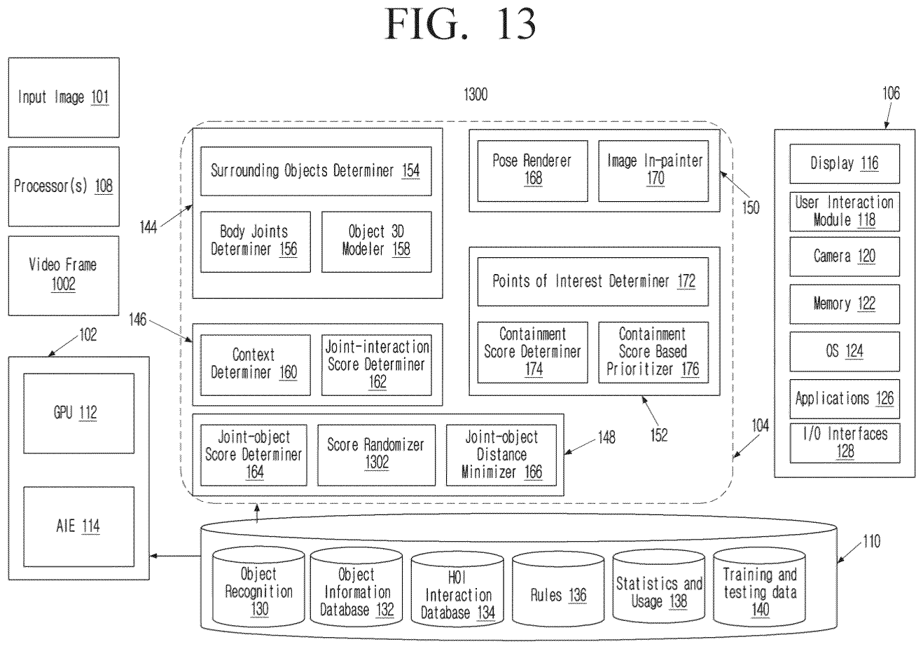

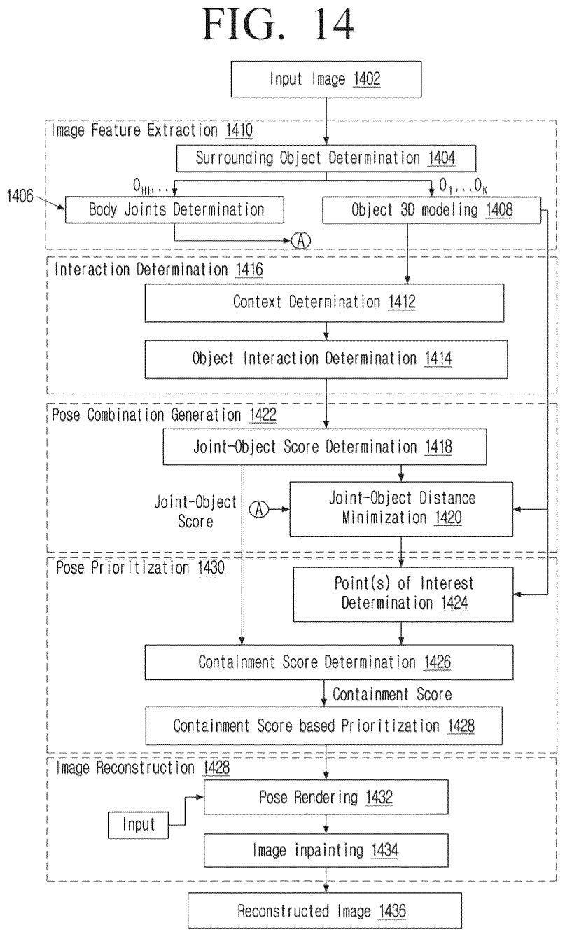

FIG. 13 illustrates a block diagram of an exemplary system 1300 for modifying the user pose in the input image 101, according to yet another one or more embodiments of the present disclosure. The system 1300 shown in FIG. 13 is similar to the system 100 explained in detail with references to FIG. 1 and FIG. 10. However, the pose combination generator 148 of the system 1300 may include a score randomizer 1302.

In one or more embodiments of the present disclosure, the score randomizer 1302 may be configured to maximize the distance between the plurality of user body joints and the at least one object to generate funny user poses. The score randomizer 1302 ensures that a pose not related to the object is generated, such that the generated pose can be used as AR stickers or Graphics Interchange Format (GIF). As an example, randomizing the scores may modify the joint-object score and move the joints randomly, which may create funny poses. The user may use these funny poses as GIFs.

FIG. 14 illustrates a process flow diagram depicting an operation of the system 100 for modifying the user pose in the input image, according to one or more embodiments of the present disclosure.

As depicted, element 1402 represents the input image, which may be the input image 101. Further, at step 1404, the at least one object is determined in the input image by first segmenting the input image to locate the at least one object. Further, at step 1406, the pose of the at least one user is determined in terms of the 2D key-joint topology. The 2D key-joint topology is then converted into the 3D pose coordinate system. At step 1408, the 3D model and the set of surface areas associated with the at least one object are generated. The step 1404, the step 1406, and the step 1408 are for performing image feature extraction 1410. Furthermore, at step 1412, the one or more contexts associated with the at least one object are determined based on the generated 3D model and the generated set of surface areas. At step 1414, the one or more possible user interactions with the at least one object are determined based on the determined one or more contexts. The step 1412 and step 1414 are for performing interaction determination 1416.

Further, at step 1418, the joint-object score is determined corresponding to the relation between a corresponding user body joint amongst a plurality of user body joints and the at least one object based on the determined one or more possible user interactions, the extracted plurality of features, and the joint-to-joint correlation. At step 1420, the set of user poses are generated corresponding to the at least one user based on the determined joint-object score. The step 1418 and step 1420 are for performing pose combination generation 1422.

Furthermore, at step 1424, the one or more points of interest are determined in the input image for each of the generated set of user poses. At step 1426, the containment score associated with each of the generated sets of user poses is determined based on the determined joint-object score and the one or more points of interest in the input image. At step 1428, the optimal user pose amongst the generated set of user poses is determined based on the determined containment score. The step 1424, step 1426, and step 1428 are for performing pose prioritization 1430.

At step 1432, the user pose associated with the at least one user and the object orientation associated with the at least one object is modified in the input image in context with the determined optimal user pose. At step 1434, the image inpainting operation is performed on the input image for reconstructing the one or more exposed spaces and the one or more hidden spaces in the input image. Further, the reconstructed image 1436 is obtained based on the result of the inpainting operation. The step 1432 and step 1434 are for performing image reconstruction 1438.

FIG. 15A, FIG. 15B, FIG. 15C, FIG. 15D, and FIG. 15E illustrate pictorial depictions showing use-case scenarios of the system 100 for modifying the user pose in the input image, according to one or more embodiments of the present disclosure.

As depicted in FIG. 15A, the user is trying to pose with the hula-hoop. However, the user is not able to click pictures (picture 1502, picture 1504, picture 1506) with satisfactory poses as either the user is not able to pose properly, or the pictures (picture 1502, picture 1504, picture 1506) are not clicked properly. Later, when the user checks the clicked pictures (picture 1502, picture 1504, picture 1506), he found the pictures (picture 1502, picture 1504, picture 1506) unsatisfactory.

Further, at step 1508, the user selects a smart pose modification mode. Furthermore, at step 1510, the system analyzes the object hula hoop and automatically generates the set of user poses with respect to the object and prioritizes the set of user poses to find the optimal pose 1512 amongst the set of user poses without requiring a reference pose.

As depicted in FIG. 15B, the user is trying to click picture, at step 1514, on a trampoline. The user is trying to pose a difficult pose while jumping on the trampoline. Further, at step 1516, the user selects a smart pose modification mode. Furthermore, at step 1518, the system analyzes the object trampoline and automatically generates the set of user poses with respect to the trampoline. Further, the set of user poses are prioritized to find the optimal pose, at step 1520, amongst the set of user poses without requiring the reference pose.

Further, in FIG. 15C, the system 100 is used to generate a pose based on the non-real objects, such as stickers or paintings. This feature of the system 100 is used to create a pose that cannot be tried by the user in a real space.

The user can use this feature to generate the appropriate pose with respect to the non-real object present in the image. At step 1522, the system 100 receives the input image i.e., the image of the user near a non-real object (a sticker of a bike on the wall). Further, at step 1524, the user provides one or more inputs to the system 100 for enhancing the pose based on the non-real objects. At step 1526, a pose is generated based on the object present in the image. In the current use-case scenario, the system 100 detects the sticker on the wall and changes the pose of the user based on the joint object.

In another use-case scenario, the user is using “motion photo” or “single take feature” to capture football tricks of his friend. In alternate solutions, a key photo is selected based on the time of photo click by the user. The alternate solutions are not configured to prioritize the frames based on the interaction between humans and objects in the frames. However, the system 100 is configured to prioritize the frames in a motion photo by using the combination prioritization steps, such that the optimal pose may be considered as the key photo. Similarly, the prioritization of the set of user poses in recorded frames can be used in features, such as “single take” to apply smart filters around the optimal pose of the user based on the at least one object.

In another use-case scenario, the system 100 may be deployed on a television, such that the television may generate the set of user poses automatically and display as a GIF in an ambient mode.

In one or more embodiments of the present disclosure, object-centric pose generation is helpful in determining the correct way of using a given equipment. In the existing solutions, the correct way of using the equipment is determined by using a standard reference pose. However, the standard reference pose may not be helpful for people having different heights or body ratios and also for children. Thus, the standard reference pose may not be as helpful for giving training related to using the equipment. In one or more embodiments of the present disclosure, the usage of object-centric information can help user to understand the posture better. For example, the user can be shown where he should hold the given equipment. In one or more embodiments of the present disclosure, defining a reference pose for all the objects may be a time-consuming task. It requires input images from several humans and from a number of directions to find the correct pose. Using object information can generalize the entire process to a great extent. The pre-defined reference pose(s) may become static in nature and may also require addition of human pose references on addition of a new equipment. Further, the new equipment may have its properties, which can help the user to pose to some extent using those properties. In a use-case scenario, the object interaction points can be used to guide the user about where to hold or take support from the home equipment. For example, during a triceps workout, the user is shown where to hold the chair. In another use-case scenario, the object interaction information can also be used in training robots to perform actions. Instead of always guiding the robots with a human reference, an intelligent method of generating the best pose around an object may be used in robotics, for wide application.

In another use-case scenario, a video is captured by the user for a video blog. The user is standing near a tree and talking about the surrounding area. When the video is captured, the user finds some consecutive frames during video edit which do not have a natural pose. The user does not want to re-capture that part of the video as it is time-consuming. Accordingly, the user opens the video editor and selects the frames which do not have the natural pose. Further, the user selects “smart pose recommendation” mode. Furthermore, the system 100 generates the set of user poses corresponding to the selected frames.

FIG. 15D depicts the use-case scenario for generating one or more unique poses. Instead of using a direct Joint-object relation, the joint-object relation can be reversed. This will make the “not related” body joints of a user to be associated with the surrounding object. The user can use this feature for generating the one or more unique poses for fun or sharing over social media. At step 1528, the user provides the input image of the user standing near the wall, to the system 100. At step 1530, the user turns off direct joint relations. Further, the system 100 generates an output image with a unique pose 1532 of the user i.e., the user lying on the floor with legs resting on the wall considering “indirect” joint-object relation. In the current use-case scenario, the legs are least related to the wall and the back/head/hands are least related to the floor. Further, 1534 represents a normal pose modification output generated using turning on the direct joint relation at step 1536.

FIG. 15E depicts the use-case scenario for modifying the pose of an avatar of the user in an AR/VR space. Existing technologies can make the avatar look like the user. The existing technologies allow the avatar to perform some predefined static actions, such as sit/stand. However, for more natural interaction, user input in terms of actuators is required. Block 1538 represents existing VR technology with basic one or more poses. In block 1538, poses of Mr. A 1540 are minimal and not natural, as Mr. A 1540 is not using VR glasses to give input. Further, pose of Ms. B 1542 seems natural because of the actuation provided by her. Further, 1544 represents a modified avatar of the user which is generated by the system 100. In one or more embodiments of the present disclosure, the modified avatar corresponds to a natural pose of the user-generated by the system 100. Further, Table 1 shows a difference between the intelligent regeneration of the pose by the system 100 and existing VR with a basic pose.

TABLE 1

| Intelligent Regeneration of pose | Existing VR with a basic pose |
|---|---|
| Intelligently “generates” the reference | The pose(s) are static or fixed as |
| pose(s) referred to as the set of user | with most of state of art AR/VR |
| poses. The set of user poses are not | cases. |
| “fixed” or “static” in any sense w.r.t | |
| the object. | |
| The set of poses are useful when | The pose(s) are useful when |
| there is limited or no user actuation | there is proper user actuation |
| input. Limited actuators include the | input. |
| VR glasses. | |
| E.g.: The smart pose is recommended | E.g.: Pose of opening the |
| to the user based on the surrounding | door, sitting, and standing, |
| object(s) of the user. The poses are | etc. may be statically mapped |
| not mapped or fixed for the avatars. | with the object and the avatar |
| | may be made to do these actions. |

In one or more embodiments of the present disclosure, the actions in VR environment are reflected by the use of actuators, such as VR glasses. When elder people are interacting in a VR environment with the actuators, due to physical strength and other reasons they are unable to do the required pose or actions. For example, arm rotation, running, etc. The system 100 may allow the user (elderly people) to generate the appropriate pose which is natural with respect to the surrounding object. Further, the specially enabled people may not be able to use the actuators properly due to their inabilities. For example, a user who has issues with legs may not be able to do actions like walking, running, playing football, and the like. The system 100 may be configured to allow the user (specially enabled) to do the appropriate actions like walking, kicking a football, and the like in VR space. Furthermore, when the accident victims are in VR space, they are unable to use the actuators which are related to the injured body part. For example, if the user is talking to someone in VR space, the hand movement is not there. The system 100 is configured to allow the avatar to move his hands freely even though the user can't move the hands in real life.

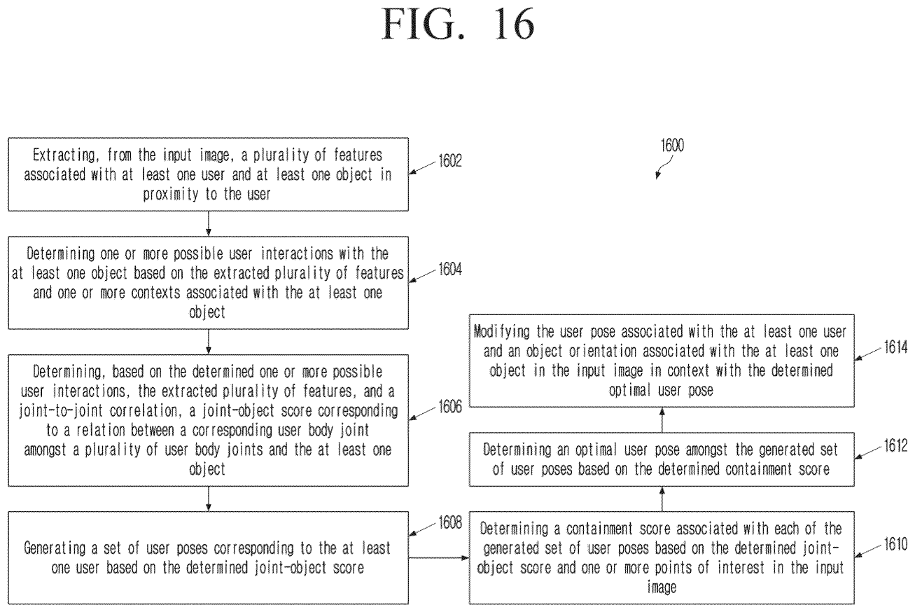

FIG. 16 illustrates a process flow diagram depicting a method 1600 for modifying the user pose in the input image, according to one or more embodiments of the present disclosure. The method 1600 may be performed by any of system 100, system 1000, system 1100, system 1200, and system 1300 implemented in an electronic device, as shown in FIG. 1, FIG. 10, FIG. 11, FIG. 12, and FIG. 13.

At step 1602, the method 1600 includes extracting, from the input image, a plurality of features associated with at least one user and at least one object in proximity to the user. In an exemplary embodiment of the present disclosure, the input image corresponds to a 2D image, a 3D image, a video frame, an AR image, or a VR image. For extracting the plurality of features, the method 1600 includes determining a plurality of user body joints of the at least one user. In one or more embodiments of the present disclosure, the plurality of user body joints together represents the user pose of the at least one user in the input image. Further, the method 1600 includes generating a 3D model and a set of surface areas associated with the at least one object.

For extracting the plurality of features, the method 1600 includes performing an input image segmentation process to divide the input image into a plurality of image segments. Further, the method 1600 includes predicting one or more image parameters for each of the plurality of image segments. In an exemplary embodiment of the present disclosure, the predicted one or more image parameters include an object class, an object box offset, a binary mask, or any combination thereof. Furthermore, the method 1600 includes masking out a set of objects and the at least one user from the input image using a set of segmentation masks and the predicted one or more image parameters. Further, the method 1600 includes identifying the at least one user in focus based on a result of masking out the set of objects and the at least one user from the input image. Further, the method 1600 includes identifying the at least one object that is in proximity to the at least one user in focus based on the masking out of the set of objects from the input image.

At step 1604, the method 1600 includes determining one or more possible user interactions with the at least one object based on the extracted plurality of features and one or more contexts associated with the at least one object. In determining the one or more possible user interactions, the method 1600 includes determining the one or more contexts associated with the at least one object based on the generated 3D model and the generated set of surface areas. Further, the method 1600 includes determining the one or more possible user interactions with the at least one object based on the determined one or more contexts.

At step 1606, the method 1600 includes determining, based on the determined one or more possible user interactions, the extracted plurality of features, and a joint-to-joint correlation, a joint-object score corresponding to a relation between a corresponding user body joint amongst a plurality of user body joints and the at least one object. For determining the joint-object score, the method 1600 includes determining a joint interaction score for each of the plurality of user body joints based on a relation of each of the plurality of user body joints with the at least one object. Further, the method 1600 includes determining the joint-to-joint correlation of the corresponding user body joint with respect to the other user body joints amongst the plurality of user body joints. The method 1600 also includes determining the joint-object score based on the determined joint interaction score and the determined joint-to-joint correlation.

At step 1608, the method 1600 includes generating a set of user poses corresponding to the at least one user based on the determined joint-object score. For generating the set of user poses, the method 1600 includes determining a plurality of surface points on each of the set of surface areas. Further, the method 1600 includes modifying one or more positions of the plurality of user body joints in the input image based on a relation associated with a distance between the plurality of user body joints and the at least one object based on the determined joint-object score, the determined plurality of surface points, and one or more predefined articulation parameters associated with the user pose. The method 1600 includes generating the set of user poses based on modification of the one or more positions of the plurality of user body joints in the input image. In one or more embodiments of the present disclosure, the relation associated with the distance between the plurality of user body joints and the at least one object corresponds to minimizing or maximizing the distance between the plurality of user body joints and the at least one object.

At step 1610, the method 1600 includes determining a containment score associated with each of the generated set of user poses based on the determined joint-object score and one or more points of interest in the input image. For determining the containment score, the method includes determining, for each of the generated set of user poses, the one or more points of interest in the input image. In one or more embodiments of the present disclosure, the one or more points of interest in the input image correspond to points that are of interest to the at least one user, points that are located on the at least one object, and points in a direction of motion of the at least one user. The points that are located on the at least one object have a higher probability of being interacted with the at least one user. The method 1600 includes identifying one or more regions around the determined one or more points of interest. The method 1600 also includes generating a region score for each of the identified one or more regions based on the distance between the identified one or more regions and the one or more points of interest. Furthermore, the method 1600 includes determining the containment score for each of the generated set of user poses based on the determined joint-object score and the generated region score.

At step 1612, the method 1600 includes determining an optimal user pose amongst the generated set of user poses based on the determined containment score.

At step 1614, the method 1600 includes modifying the user pose associated with the at least one user and an object orientation associated with the at least one object in the input image in context with the determined optimal user pose. In one or more embodiments of the present disclosure, the method 1600 includes identifying one or more exposed spaces and one or more hidden spaces in the input image upon modifying the user pose and the object orientation in the input image. Further, the method 1600 includes performing an image in-painting operation on the input image for reconstructing the identified one or more exposed spaces and the identified one or more hidden spaces.

Further, the method 1600 includes identifying a context type of the input image based on the at least one object and surrounding scenes in the input image. The method 1600 also includes determining the optimal user pose amongst the generated set of user poses based on the determined containment score and the identified context type.

Furthermore, the method 1600 includes determining a priority of the at least one object based on one or more object parameters. In one or more embodiments of the present disclosure, the one or more object parameter corresponds to parameters associated with a distance relationship between the at least one user and the at least one object in the input image, parameters associated with an object type of the at least one object, parameters associated with the object orientation, and parameters associated with the user pose. The method 1600 includes generating the set of user poses corresponding to the at least one user based on the determined joint-object score and the determined priority. In one or more embodiments of the present disclosure, the method 1600 includes receiving at least one user input to prioritize the at least one object for generating the set of user poses. Furthermore, the method 1600 includes generating the set of user poses corresponding to the at least one user based on the received at least one user input and the determined joint-object score.

While the above steps shown in FIG. 16 are described in a particular sequence, the steps may occur in variations to the sequence in accordance with various embodiments of the present disclosure. Further, the details related to various steps of FIG. 16, which are already covered in the description related to FIGS. 1 through 15E are not discussed again in detail here for the sake of brevity.

The present disclosure provides for various technical advancements based on the key features discussed above. The present disclosure regenerates poses of the user based on the properties of living surrounding objects without considering a reference pose. Further, the present disclosure generates the set of user poses which opens a possibility of a wider variety of reference pose generation, which may or may not have been thought by the user. Existing photo modification tools focus more on editing the photos by changing filters or by embedding a text or sticker over the photo. Further, existing pose modification tools require a reference pose for rendering the updated pose. However, the present disclosure generates a set of user poses which are apt according to the surrounding objects without the requirement of the reference pose. Further, the present disclosure selects the most optimal pose from the set of user poses, such that the most optimal pose may then be used for pose transfer. Further, the present disclosure can change the pose of the user in a clicked photograph and a frame of the movie. The present disclosure also generates the reference pose to make the modified pose of the user appealing and natural. The present disclosure generates the set of user poses by using the object properties and information related to an object, joint correlation, and probable interaction points using the object characteristics. The present disclosure uses human-object interaction and generates the best naturally looking pose that is not even tried by the user. The present disclosure may be used in many applications such as pose modification in a clicked photo or video or rendering a GIF around a user's pose or, for a more natural pose of the user.

The plurality of modules 104 may be implemented by any suitable hardware and/or set of instructions. Further, the sequential flow illustrated in FIG. 1 is exemplary in nature and the embodiments may include the addition/omission of steps as per the requirement. In some embodiments, the one or more operations performed by the plurality of modules 104 may be performed by the processor/controller based on the requirement.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one or more embodiments may be added to another embodiment.

What is claimed is:

1. A system for modifying an input user pose from an input image, the system comprising:
a memory;
one or more processors communicably coupled to the memory, the one or more processors are configured to:
extract, from the input image, a plurality of features associated with at least one user and at least one object;
determine, based on the extracted plurality of features and one or more contexts predetermined as associated with the at least one object, one or more possible user interactions with the at least one object;
determine, based on the determined one or more possible user interactions, the extracted plurality of features, and a joint-to-joint correlation, a joint-object score representing a relation between a user body joint, amongst a plurality of user body joints of the at least one user, and the at least one object;
generate, based on the determined joint-object score, a set of user poses corresponding to the at least one user;
determine, based on the determined joint-object score and one or more points of interest in the input image, a containment score associated with each user pose of the generated set of user poses;
determine, based on the determined containment score and as an optimal user pose, one of the user poses amongst the generated set of user poses; and
modify, in the input image and based on the determined optimal user pose, the input user pose and an object orientation associated with the at least one object.

2. The system as claimed in claim 1, wherein extracting the plurality of features comprises:
determining the plurality of user body joints of the at least one user, wherein the plurality of user body joints collectively represents the input user pose from the input image; and
generating a three-dimensional (3D) model and a set of surface areas of the at least one object.

3. The system as claimed in claim 2, wherein extracting the plurality of features further comprises determining, based on the generated 3D model and the generated set of surface areas, the one or more contexts.

4. The system as claimed in claim 2, wherein generating the set of user poses comprises:
determining a plurality of surface points on each surface area of the set of surface areas;
modifying, based on a relation associated with a distance between the plurality of user body joints and the at least one object, one or more positions of the plurality of user body joints in the input image, the relation is based on the determined joint-object score, the determined plurality of surface points, and one or more predefined articulation parameters associated with the user pose; and
generating, further based on modifying the one or more positions of the plurality of user body joints in the input image, the set of user poses.

5. The system as claimed in claim 4, wherein the relation associated with the distance between the plurality of user body joints and the at least one object is further based on one of minimizing and maximizing the distance between the plurality of user body joints and the at least one object.

6. The system as claimed in claim 1, wherein the input image represents at least one of a two-dimensional (2D) image, a three-dimensional (3D) image, a video frame, an Augmented Reality (AR) image, and a Virtual Reality (VR) image.

7. The system as claimed in claim 1, wherein determining the containment score comprises:
determining, for said each user pose of the generated set of user poses, the one or more points of interest in the input image, wherein the one or more points of interest in the input image are estimated to be of interest to the at least one user, are points that are located on the at least one object, and correspond to a direction of motion of the at least one user, and wherein the points that are located on the at least one object are determined to have a higher probability of being interacted with by the at least one user than other points from the input image;
identifying one or more regions around the determined one or more points of interest; and
generating, based on a distance between the identified one or more regions and the one or more points of interests, a region score of each of the identified one or more regions.

8. The system as claimed in claim 1, wherein extracting the plurality of features comprises:
performing an input image segmentation process comprising dividing the input image into a plurality of image segments;
predicting one or more image parameters of each of the plurality of image segments, wherein the predicted one or more image parameters comprise at least one of an object class, an object box offset, and a binary mask;
masking out, based on a set of segmentation masks and the predicted one or more image parameters, a set of objects and the at least one user from the input image;
identifying, based on a result of masking out the set of objects and the at least one user from the input image, the at least one user; and
identifying, based on the masking out of the set of objects from the input image, the at least one object.

9. The system as claimed in claim 1, wherein determining the joint-object score comprises:
determining, based on a relation of each of the plurality of user body joints with the at least one object, a joint interaction score for each of the plurality of user body joints;
determining the joint-to-joint correlation of a user body joint, of the plurality of user body joints, with respect to other user body joints amongst the plurality of user body joints; and
determining the joint-object score further based on the determined joint interaction score and the determined joint-to-joint correlation.

10. The system as claimed in claim 1, wherein the one or more processors are further configured to:
identify, in the input image and based on modifying the input user pose, one or more exposed spaces and one or more hidden spaces upon modifying, in the input image, the input user pose and the object orientation; and
perform an image in-painting operation on the input image, the image in-painting operation comprising reconstructing the identified one or more exposed spaces and the identified one or more hidden spaces.

11. The system as claimed in claim 1, wherein the one or more processors are further configured to:
identify, based on the at least one object and one or more surrounding scenes in the input image, a context type of the input image; and
determine, based on the determined containment score and the identified context type, the optimal user pose amongst the generated set of user poses.

12. The system as claimed in claim 1, wherein the one or more processors are further configured to determine, based on one or more object parameters, a priority of the at least one object, wherein the one or more object parameters represent parameters of any of a distance relationship between the at least one user and the at least one object in the input image, an object type of the at least one object, the object orientation, and the user pose, and
generating the set of user poses corresponding to the at least one user is further based on the determined priority.

13. The system as claimed in claim 1, wherein the one or more processors are further configured to receive at least one user input to prioritize the at least one object in generating the set of user poses, and
generating the set of user poses corresponding to the at least one user is further based on the received at least one user input.

14. A method for modifying a user pose in an input image, the method comprising:
extracting, from the input image, a plurality of features associated with at least one user and at least one object;
determining, based on the extracted plurality of features and one or more contexts predetermined as associated with the at least one object, one or more possible user interactions with the at least one object;
determining, based on the determined one or more possible user interactions, the extracted plurality of features, and a joint-to-joint correlation, a joint-object score representing a relation between a user body joint, amongst a plurality of user body joints of the at least one user, and the at least one object;
generating, based on the determined joint-object score, a set of user poses corresponding to the at least one user;
determining, based on the determined joint-object score and one or more points of interest in the input image, a containment score associated with each user pose of the generated set of user poses;
determining, based on the determined containment score and as an optimal user pose, one of the user poses amongst the generated set of user poses; and
modifying, in the input image and based on the determined optimal user pose, the input user pose and an object orientation associated with the at least one object.

15. The method as claimed in claim 14, wherein extracting the plurality of features comprises:
determining the plurality of user body joints of the at least one user, wherein the plurality of user body joints collectively represents the input user pose from the input image; and
generating a three-dimensional (3D) model and a set of surface areas of the at least one object.
